(19) United States
(12) Patent Application Publication
(10) Pub. No.: US 2007/0091135 A1
(43) Pub. Date: Apr. 26, 2007

(54) Image processing method, image processing apparatus, and computer-readable recording medium

(76) Inventors: Shigetoshi Hosaka, Kanagawa (JP); Masakazu Yoshida, Kanagawa (JP); Takashi Kimura, Kanagawa (JP); Masanori Hirano, Kanagawa (JP)

Correspondence Address: COOPER & DUNHAM, LLP, 1185 AVENUE OF THE AMERICAS, NEW YORK, NY, 10036, US

(21) Appl. No.: 11/585,422

(22) Filed: Oct. 23, 2006

(30) Foreign Application Priority Data
Oct. 25, 2005 (JP) 2005-310187

(51) Int. Cl. B41J 2/205

(52) U.S. Cl. 347/15

(57) ABSTRACT

An image processing method for processing image data to be output by an image forming apparatus is disclosed. The image forming apparatus is configured to form a tone pattern on a recording medium by forming an arrangement of dots on the recording medium. The arrangement of dots is formed on the recording medium by jetting a recording liquid from a recording head while moving the recording head in a main scanning direction a plurality of times and intermittently conveying the recording medium in a sub-scanning direction that perpendicularly intersects the main scanning direction. The method includes the step of generating a mask pattern for moving the recording head in the main scanning direction and forming the dots in an inconsecutive order on the recording medium.

### BACKGROUND OF THE INVENTION

1. Field of the Invention

The present invention relates to an image processing method, an image processing apparatus, and a computer-readable recording medium.

2. Description of the Related Art

An inkjet recording apparatus, which uses a liquid jetting head as its recording head, is one example of an image forming apparatus (including a printer, a facsimile machine, a copy machine, or a multifunction machine having a printing function, facsimile function, and a copying function). The inkjet recording apparatus forms (i.e. records, prints )images by jetting ink (i.e. recording liquid) from its recording head and onto the surface of a recording medium, for example, a sheet of paper or an OHP sheet. It is to be noted that the recording medium includes any medium onto which an ink droplet or a liquid of the like can adhere.

The image forming apparatus can jet recording liquid droplets in sizes of, for example, four different types (four tones), which are “no dots”, “small dots”, “medium dots”, and “large dots”. Therefore, the image forming apparatus is unable to form multiple tones with the recording liquid droplets. Thus, a dither method or an error diffusion method is used for reproducing halftones by combining density gradation (intensity modulation) of a lower level than that of the original image and area gradation (area modulation).

The dither method (binary dither method) uses the value of each matrix in a dither matrix as a threshold value, compares the value of the dither matrix with the density of a pixel of a corresponding coordinate, and determines whether to output 1 (print or illuminate at a target pixel) or 0 (no printing or illuminating at a target pixel), to thereby obtain a binarized image. This method can obtain binarized data for area gradation by simply comparing the input image data and the threshold values and can perform calculations at high speed. One example of a halftone pattern used in a halftoning process of the dither method is an orderly linear tone (e.g. diagonal line tone).

Meanwhile, a serial type (also referred to as a shuttle type or a serial scan type) inkjet recording apparatus forms images by moving a recording head mounted on a carriage in a main scanning direction (also referred to as “main scanning”) and intermittently conveying a recording medium in a sub-scanning direction. More specifically, the serial type inkjet recording apparatus forms images by using a multi-pass method and an interlace method. In conducting the multi-pass method, a group of nozzles or different groups of nozzles scan the same area of the recording medium in the main scanning direction plural times, so that a high quality image can be formed. In conducting the interlace method, an image is formed by interlacing the same area by adjusting the amount of conveying the recording medium in the sub-scanning direction and moving the recording head in the main scanning direction plural times.

In forming an image by combining the multi-pass method and the interlace method, the order for recording dots (e.g. order of applying ink droplets, order of aligning ink droplets) can be arranged as a matrix. This matrix is referred to as a mask pattern (also referred to as recording sequence matrix).

High quality images can be formed by utilizing the mask pattern. For example, in the inkjet recording apparatus disclosed in Japanese Laid-Open Patent Application No. 2002-96455, different groups of nozzles scan the same main scan recording area of the recording medium in the main scanning direction plural times. Moreover, the inkjet recording apparatus includes a part for forming a thinned out (pixel skipped) image in accordance with a thin-out mask pattern by scanning a recording area in the main scanning direction plural times and a recording duty setting part for dividing the same recording area in a sub-scanning direction at a predetermined pitch and setting recording duties with different values in accordance with the thin-out mask pattern with respect to each divided area.

In another example, Japanese Registered Patent No. 3507415 discloses a recording apparatus having a control part for using dot arrangement patterns corresponding to a level of quantized image data to form dots corresponding to the level of the image data on a printed medium. The control part is capable of periodically changing the plural dot arrangement patterns used for the same level of the image data, wherein the plural dot arrangement patterns used for the same level of the image data are such that within each period when the patterns are periodically used, the number of dots formed in each of the N rasters are equalized, whereas the number of dots formed in the M columns are equalized, and P, N, and M are each an integral equal to or larger than 2. The plural dot arrangement patterns periodically used for the same level of the image data are such that within each period when the patterns are repeatedly used, when the dots formed using at least one of the plural dot arrangement patterns are shifted at least two pixels in the main-scanning direction, a variation in the ratio of a printing surface of the printing medium which corresponds to a printing range for the dot arrangement pattern occupied by a surface on which dots are formed using the plural dot arrangement patterns is limited to 10% or less.

In yet another example, Japanese Laid-Open Patent Application No. 2005-001221 discloses an inkjet recording apparatus using a halftone process mask in which the line base tone of a halftone pattern forms dots that always synchronize with the dots formed by performing a combination of multi-passing and interlacing with a serial head.

Conventionally, in a case of forming halftones with a line base tone, the impact points where the droplets contact the recording medium tend to vary for each tone. This leads to reduction of image quality due to problems such as uneven printing results and banding.

Even with the above-described apparatuses disclosed in Japanese Laid-Open Patent Application No. 2002-96455 and Japanese Registered Patent No. 3507415, the impact points tend to vary as the mask pattern becomes larger. Accordingly, this may lead to uneven printing results and banding. Furthermore, these apparatuses are unable to solve the problems in which the line tone used in a halftone process has to face.

### SUMMARY OF THE INVENTION

The present invention may provide an image processing method, an image processing apparatus, and a computer-readable recording medium that substantially obviates one or more of the problems caused by the limitations and disadvantages of the related art.

Features and advantages of the present invention are set forth in the description which follows, and in part will become apparent from the description and the accompanying drawings, or may be learned by practice of the invention according to the teachings provided in the description. Objects as well as other features and advantages of the present invention will be realized and attained by an image processing method, an image processing apparatus, and a computer-readable recording medium particularly pointed out in the specification in such full, clear, concise, and exact terms as to enable a person having ordinary skill in the art to practice the invention.

To achieve these and other advantages and in accordance with the purpose of the invention, as embodied and broadly described herein, an embodiment of the present invention provides an image processing method for processing image data to be output by an image forming apparatus, the image forming apparatus being configured to form a tone pattern on a recording medium by forming an arrangement of dots on the recording medium, the arrangement of dots being formed on the recording medium by jetting a recording liquid from a recording head while moving the recording head in a main scanning direction a plurality of times and intermittently conveying the recording medium in a sub-scanning direction that perpendicularly intersects the main scanning direction, the method including the step of: generating a mask pattern for moving the recording head in the main scanning direction and forming the arrangement of dots in an inconsecutive order on the recording medium.

In the image processing method according to an embodiment of the present invention, when the arrangement of dots is expressed by using the degree of scattering, the arrangement of dots may be no greater than 5, wherein the degree of scattering is expressed as Σ (interval of main scanning movement during dot forming operation−average of the intervals)²/number of scans for forming the tone pattern.

In the image processing method according to an embodiment of the present invention, the mask pattern may include a pattern that defines the order of forming the dot arrangement in accordance with the results of a halftone process.

In the image processing method according to an embodiment of the present invention, the mask pattern may include a halftone pattern used in a halftone process.

In the image processing method according to an embodiment of the present invention, the mask pattern may have a size that is different from the size of a halftone pattern used in a halftone process.

Furthermore, another embodiment of the present invention provides an image processing apparatus for processing image data to be output by an image forming apparatus, the image forming apparatus being configured to form a tone pattern on a recording medium by forming an arrangement of dots on the recording medium, the arrangement of dots being formed on the recording medium by jetting a recording liquid from a recording head while moving the recording head in a main scanning direction a plurality of times and intermittently conveying the recording medium in a sub-scanning direction that perpendicularly intersects the main scanning direction, the image processing apparatus including: a mask pattern generating part for generating a mask pattern for moving the recording head in the main scanning direction and forming the arrangement of dots in an inconsecutive order on the recording medium.

In the image processing apparatus according to an embodiment of the present invention, when the arrangement of dots is expressed by using the degree of scattering, the arrangement of dots may be no greater than 5, wherein the degree of scattering is expressed as Σ (interval of main scanning movement during dot forming operation−average of the intervals)²/number of scans for forming the tone pattern.

In the image processing apparatus according to an embodiment of the present invention, the mask pattern may include a pattern that defines the order of forming the dot arrangement in accordance with the results of a halftone process.

In the image processing apparatus according to an embodiment of the present invention, the mask pattern may include a halftone pattern used in a halftone process.

In the image processing apparatus according to an embodiment of the present invention, the mask pattern may have a size that is different from the size of a halftone pattern used in a halftone process.

Furthermore, another embodiment of the present invention provides a computer-readable recording medium on which a program is recorded for causing a computer to execute an image processing method for processing image data to be output by an image forming apparatus, the image forming apparatus being configured to form a tone pattern on a recording medium by forming an arrangement of dots on the recording medium, the arrangement of dots being formed on the recording medium by jetting a recording liquid from a recording head while moving the recording head in a main scanning direction a plurality of times and intermittently conveying the recording medium in a sub-scanning direction that perpendicularly intersects the main scanning direction, the method including the step of: generating a mask pattern for moving the recording head in the main scanning direction and forming the arrangement of dots in an inconsecutive order on the recording medium.

In the computer-readable recording medium according to an embodiment of the present invention, when the arrangement of dots is expressed by using the degree of scattering, the arrangement of dots may be no greater than 5, wherein the degree of scattering is expressed as Σ (interval of main scanning movement during dot forming operation−average of the intervals)²/number of scans for forming the tone pattern.

In the computer-readable recording medium according to an embodiment of the present invention, the mask pattern may include a pattern that defines the order of forming the dot arrangement in accordance with the results of a halftone process.

In the computer-readable recording medium according to an embodiment of the present invention, the mask pattern may include a halftone pattern used in a halftone process.

In the computer-readable recording medium according to an embodiment of the present invention, the mask pattern may have a size that is different from the size of a halftone pattern used in a halftone process.

Other objects and further features of the present invention will be apparent from the following detailed description when read in conjunction with the accompanying drawings.

### BRIEF DESCRIPTION OF THE DRAWINGS

FIG. 1 is a side view showing a mechanism part of an image forming apparatus for forming an image according to image data (mask pattern) generated by using an image processing method according to an embodiment of the present invention;

FIG. 2 is a plan view of the mechanism part of the image forming apparatus shown in FIG. 1;

FIG. 3 is a cross-sectional view along a longitudinal direction of a liquid chamber of the recording head according to an embodiment of the present invention;

FIG. 4 is a cross-sectional view along a lateral direction of the liquid chamber of the recording head according to an embodiment of the present invention;

FIG. 5 is a block diagram showing a control part of the image forming apparatus according to an embodiment of the present invention;

FIG. 6 is a schematic diagram showing an image forming system according to an embodiment of the present invention;

FIG. 7 is a block diagram showing an example of an image processing apparatus in the image forming system shown in FIG. 6;

FIG. 8 is a block diagram showing a configuration (functions) of a printer driver (program) according to an embodiment of the present invention;

FIG. 9 is a block diagram showing a configuration (functions) of a printer driver (program) according to another embodiment of the present invention;

FIGS. 10A and 10B are diagrams for describing an example of a mask pattern formed with a combination of a multi-pass method and an interlace method;

FIGS. 11A and 11B are diagrams for describing the order of dots printed with a combination of a mask pattern and a tone pattern of halftone according to a comparative example;

FIGS. 12A and 12B are diagrams for describing the order of dots printed with a combination of a mask pattern and a tone pattern of halftone according to an example of the present invention;

FIGS. 13A and 13B are diagrams for describing the order of dots printed with a combination of a mask pattern and a tone pattern of halftone according to another example of the present invention;

FIGS. 14A and 14B are diagrams for describing the order of dots printed with a combination of a mask pattern and a tone pattern of halftone according to yet another example of the present invention;

FIG. 15 is a diagram for describing the order of dots printed with a combination of a mask pattern and a tone pattern of halftone according to a comparative example in a case of 4 pass ¼ interlace (⅙ tone);

FIG. 16 is a diagram for describing the order of dots printed with a combination of a mask pattern and a tone pattern of halftone according to an example of the present invention in a case of 4 pass ¼ interlace (⅙ tone);

FIG. 17 is a diagram for describing the order of dots printed with a combination of a mask pattern and a tone pattern of halftone according to an example of the present invention in a case of 4 pass ¼ interlace (⅕ tone);

FIG. 18 is a diagram for describing the order of dots printed with a combination of a mask pattern and a tone pattern of halftone according to a comparative example in a case of 4 pass ⅛ interlace (⅙ tone);

FIG. 19 is a diagram for describing the order of dots printed with a combination of a mask pattern and a tone pattern of halftone according to an example of the present invention in a case of 4 pass ⅛ interlace (⅙ tone);

FIG. 20 is a diagram for describing the order of dots printed with a combination of a mask pattern and a tone pattern of halftone according to an example of the present invention in a case of 4 pass ⅛ interlace (⅕ tone);

FIG. 21 is a diagram for describing an overall configuration of an image forming apparatus according to another embodiment of the present invention; and

FIG. 22 is a block diagram of a control part of the image forming apparatus shown in FIG. 21.

### DESCRIPTION OF THE PREFERRED EMBODIMENTS

In the following, embodiments of the present invention are described with reference to the accompanying drawings.

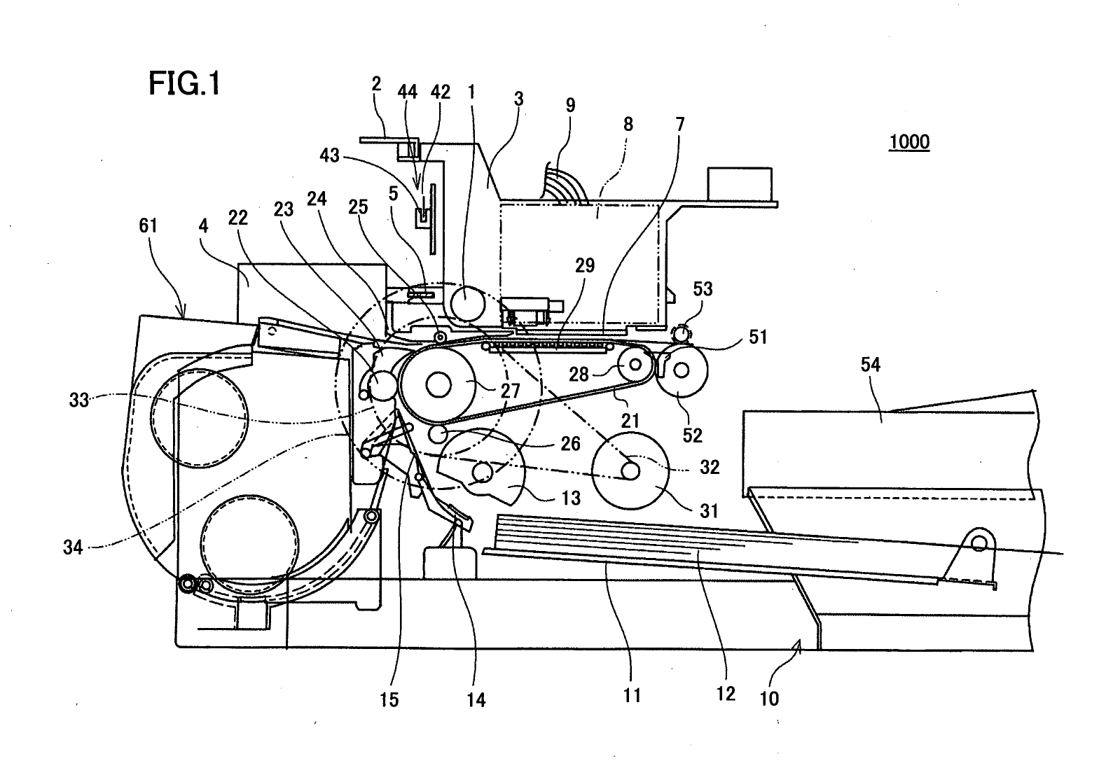

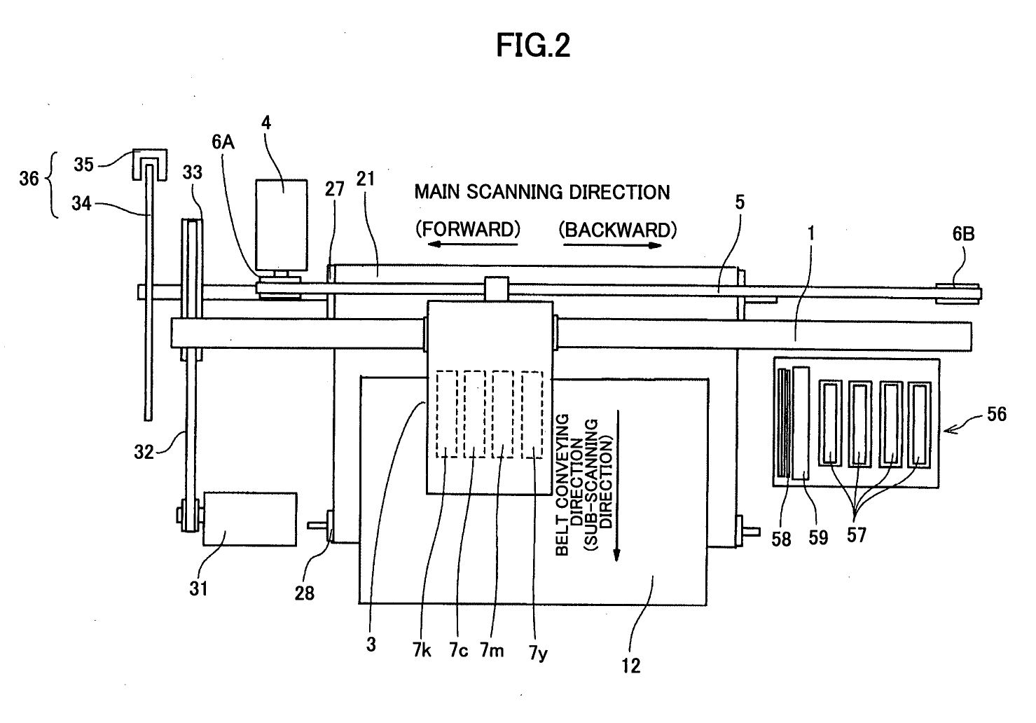

First, an example of an image forming apparatus 1000 outputting image data generated by an image processing method of the present invention is described with reference to FIGS. 1 and 2. FIG. 1 is a side view showing a mechanism part of the image forming apparatus 1000 according to an embodiment of the present invention. FIG. 2 is a plan view of the mechanism part of the image forming apparatus 1000 shown in FIG. 1.

The image forming apparatus 1000 has guide members including a guide rod 1 and a guide rail 2. The guide rod 1 and the guide rail 2 are mounted in traversed positions between left and right side boards (not shown) of the image forming apparatus 1000. The guide rod 1 and the guide rail 2 hold a carriage 3 so that the carriage 3 can slide in the main scanning direction. A main scanning motor 4 drives the sliding movement of the carriage 3 via a timing belt 5 stretched between a driving pulley 6A and a driven pulley 6B. Thereby, the carriage 3 is able to travel (scan) in the arrow directions shown in FIG. 2 (main scanning direction).

The carriage 3 has a recording head (liquid jetting head) 7 including, for example, four recording head parts 7y, 7c, 7m, and 7k for jetting ink droplets of yellow (Y), cyan (C), magenta (M), and black (K), respectively. The recording head 7 having plural ink jetting holes aligned in a direction perpendicular to the main scanning direction is attached to the carriage 3 so that ink droplets can be jetted downward therefrom.

The recording head 7 may include a pressure generating part that generates pressure used for jetting ink droplets from the recording head 7. For example, the pressure generating part may be a thermal actuator which utilizes the pressure changes of ink boiled by an electric heat converting element (e.g. heating resistor), a shape-memory alloy actuator which utilizes the changes of shape of an alloy in accordance with temperature, or an electrostatic actuator utilizing static electricity. Furthermore, the recording head 7 is not limited to having plural recording head parts corresponding to each color. For example, the recording head 7 may have plural ink jetting nozzles for jetting ink of plural colors.

Moreover, the carriage 3 has a sub-tank 8 for supplying ink of each color to the recording head 7. The sub-tank 8 is supplied with ink from a main tank (i.e. ink cartridge, not shown) via an ink supplying tube(s) 9.

Furthermore, the image forming apparatus 1000 includes a sheet feeding portion for feeding sheets of paper 12 stacked on a sheet stacking part 11 of a sheet feed cassette 10. The sheet feeding portion includes a separating pad 14 having a friction coefficient sufficient for separating sheets of paper 12 from the sheet stacking part and a sheet feeding roller 13 (in this example, a half moon shaped roller) for conveying the sheets of paper 12 one at a time from the sheet stacking part 11. The separating pad 14 is configured to urge the sheets in the direction toward the sheet feeding roller 13.

The paper 12 conveyed from the sheet feeding part is conveyed to an area below the recording head 7. In order to convey the paper 12 to the area below the recording head 7, the image forming apparatus 1000 is provided with a conveyor belt 21 that conveys the paper 12 by attracting the paper 12 with electrostatic force; a counter roller 22 and the conveyor belt 21 having the paper 12 delivered inbetween after receiving the paper 12 conveyed from the sheet feeding part via a guide 15; a conveyor belt guide 23 for placing the paper 12 flat on the conveyor belt 21 by changing the orientation of the paper 12 conveyed in a substantially upright (perpendicular) position by an angle of approximately 90 degrees; and a pressing member 24 for pressing a pressing roller 25 against the conveyor belt 21. Furthermore, the image forming apparatus 1000 includes a charging roller (charging part) 26 for charging the surface of the conveyor belt 21.

In this example, the conveyor belt 21 is an endless belt stretched between a conveyor roller 27 and a tension roller 28. A sub-scanning motor 31 rotates the conveyor roller 27 via a timing belt 21 and a timing roller 33 so that the conveyor belt 21 is rotated in the belt conveying direction shown in FIG. 2 (sub-scanning direction). It is to be noted that a guide member 29 is positioned at the backside of the conveyor belt 21 in correspondence with a target image forming area of the recording head 7. Furthermore, the charging roller 26 is positioned contacting the top surface of the conveyor belt 21 so that the charging roller 26 rotates in accordance with the rotation of the conveyor belt 21.

As shown in FIG. 2, the image forming apparatus 1000 also includes a rotary encoder 36. The rotary encoder 36 includes a slit disk 34 attached to a rotary shaft of the conveyor roller 27 and a sensor 35 for detecting a slit(s) formed in the slit disk 34.

The image forming apparatus 1000 also includes a sheet discharging portion for discharging the sheet of paper 12 onto which data are recorded by the recording head 7. The sheet discharging portion includes a separating claw 51 for separating the paper 12 from the conveyor belt 21, a first sheet discharging roller 53, a second sheet discharging roller 53, and a sheet discharge tray 54 for stacking the paper(s) 12 thereon.

Furthermore, a double-side sheet feeding unit (not shown) may be detachably attached to a rear portion of the image forming apparatus 1000. By rotating the conveyor belt in the reverse direction, the paper 12 is delivered to the double-side sheet feeding unit so as to have the paper 12 flipped upside down. Then, the flipped paper 12 is conveyed back to the part between the counter roller 22 and the conveyor belt 21.

Furthermore, as shown in FIG. 2, a nozzle recovery mechanism 56 for maintaining/restoring the operating status of the nozzle(s) may be provided at a non-printing area toward one side (in this example, toward the back side) of the main scanning direction of the carriage 3.

The nozzle recovery mechanism 56 includes, for example, plural caps 57 for covering the surface of each of the nozzles of the recording head 7, a wiper blade 58 for wiping off residual ink from the surface of the nozzles, and an ink receptacle 59 for receiving accumulated ink that is jetted in a process of disposing of undesired ink.

Accordingly, with the image forming apparatus 1000 having the above-described configuration, sheets of paper 12 are separated and conveyed sheet by sheet from the sheet feeding part, then the separated conveyed paper 12 is guided to the part between the conveyor belt 21 and the counter roller 22 in an upright manner by the guide 15, and then the orientation of the conveyed paper is changed approximately 90 degrees by guiding the tip part of the paper with the conveyor guide 23 and pressing the paper 12 against the conveyor belt 21 with the pressing roller 25.

In this conveying operation, an AC bias supplying part of a control part (not shown) of the image forming apparatus 1000 alternately applies negative and positive alternate voltages to the charging roller 26 in accordance with an alternate charging pattern. Thereby, the conveyor belt 21 is alternately charged with negative and positive voltages at intervals of a predetermined width in accordance with the alternate charging pattern. When the paper 12 is conveyed onto the charged conveyor belt 21, the paper 12 is attracted to the conveyor belt 21 by electrostatic force. Thus held, the paper 12 is conveyed in the sub-scanning direction by the rotation of the conveyor belt 21.

Then, the recording head 7 jets ink droplets onto the paper 12 while the paper 12 is being moved in correspondence with the forward and backward movement of the carriage 3. After the recording head 7 records (prints) a single row by jetting ink in accordance with image signals, the paper 12 is further conveyed a predetermined distance for recording the next row. The recording operation of the recording head 7 is completed when a signal is received indicative of the completion of the recording operation or indicative of the rear end of the paper 12 reaching the edge of the recording area. After the completion of the recording operation, the paper is discharged to the discharge tray 54.

In a case of conducting double side printing, the paper 12 is flipped upside down after the recording of the front side (the side which is printed first) of the paper 12 is completed. The paper 12 is flipped so that the back side of the paper is the printing surface by rotating the conveyor belt 21 in reverse and delivering the paper 12 to the double side sheet feeding unit (not shown). Then, the flipped paper 12 is conveyed to the part between the counter roller 22 and the conveyor belt 21. After the paper 12 is placed on the conveyor belt 21, the recording head 7 conducts the above-described recording operation on the back side of the paper 12. After the recording operation is completed, the paper 12 is discharged to the discharge tray 54.

In a case where the image forming apparatus 1000 is standing by to conduct a printing (recording) operation, the carriage 3 is moved toward the recovery mechanism 56. The cap 57 covers the nozzle side of the recording head 7 to keep the nozzles moist. This prevents poor jetting performance caused by dried ink. Furthermore, where the cap covers the nozzle side of the recording head 7, a recovery operation may be performed by suctioning accumulated viscous ink (recording liquid) from the nozzles and ejecting the ink and bubbles. Then, the wiper blade 58 wipes off the ink that has adhered to the nozzle side of the recording head 7 during the recovery operation. Furthermore, an empty jetting (idling) operation may be performed in which immaterial ink is jetted, for example, prior to a recording operation or during the recording operation.

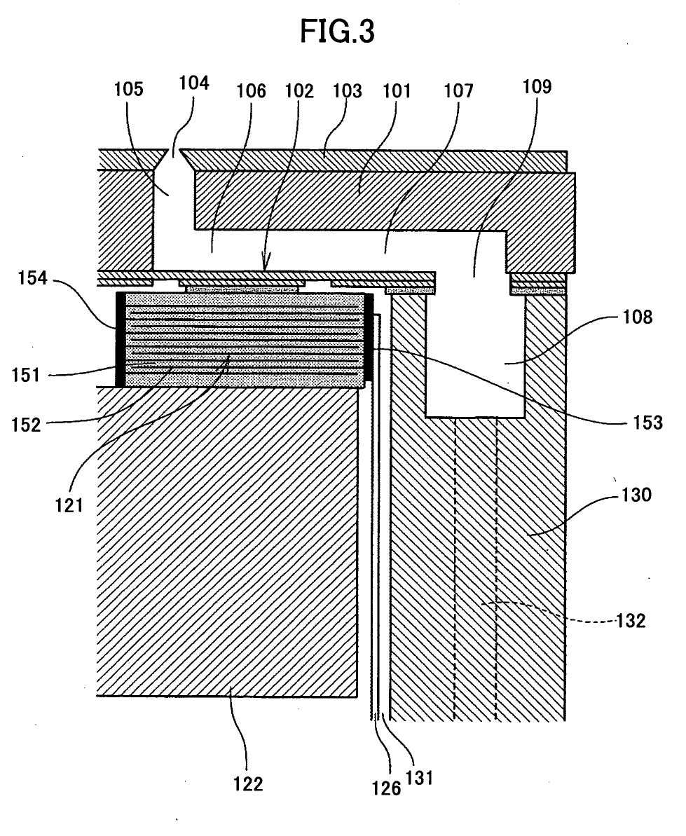

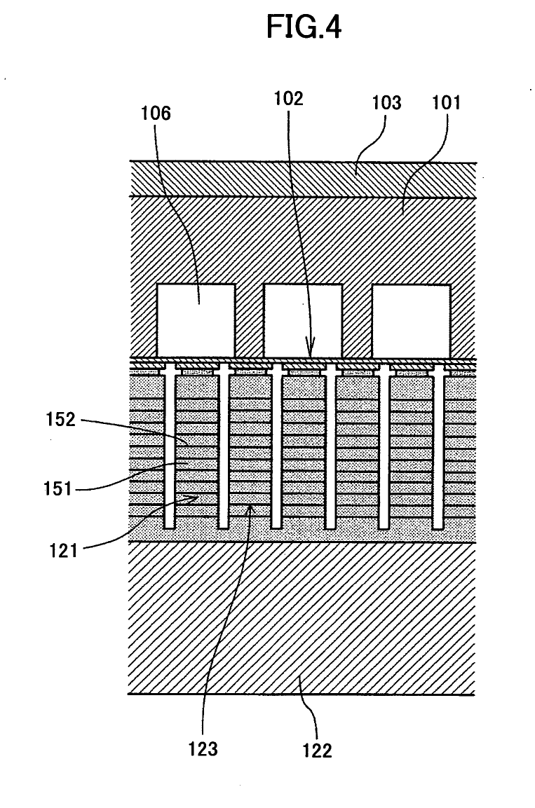

Next, an example of a recording head part included in the recording head 7 is described with reference to FIGS. 3 and 4. FIG. 3 is a cross-sectional view along a longitudinal direction of a liquid chamber of the recording head 7. FIG. 4 is a cross-sectional view along a lateral direction of the liquid chamber of the recording head 7.

The recording head 7 includes a layered structure formed by bonding together a flow plate 101 (for example, formed by performing anisotropic etching on a single crystal silicon substrate), a vibration plate 102 (for example, formed by performing electroforming on a nickel plate) provided on a lower surface of the flow plate 101, and a nozzle communication path 103 provided on an upper surface of the flow plate 101. This layered structure is formed with, for example, a nozzle communication path 105 in flow communication with the nozzle(s) 104 of the recording head 7, a liquid chamber 106 serving as a pressure generating chamber, a common liquid chamber 108 for supplying ink to the liquid chamber 106 via a fluid resistance part (supply path) 107, and an ink supply port 109 in flow communication with the common liquid chamber 108.

Furthermore, the recording head 7 includes two rows (although only one row is illustrated in FIG. 3) of layered structure type piezoelectric elements (also referred to as “pressure generating part” or “actuator part”) 121 for applying pressure to the ink inside the liquid chamber 106 by deforming the vibration plate 102, and a base substrate 122 affixed to the piezoelectric elements 121. It is to be noted that plural pillar parts 123 are formed in-between the piezoelectric elements 121. Although the pillar parts 123 are formed at the same time of forming the piezoelectric elements 121 when cutting a base material of the piezoelectric element 121, the pillar parts 123 simply become normal pillars since no drive voltage is applied thereto.

Furthermore, the piezoelectric element 121 is connected to an FPC cable 126 on which a driving circuit (driving IC, not shown) is mounted.

The peripheral portions of the vibration plate 102A are bonded to a frame member 130. The frame member 130 is fabricated to form a void portion 131 for installing an actuator unit (including, for example, the piezoelectric element 121, the base substrate 122) therein, a concave part including the common liquid chamber 108, and an ink supply hole 132 for supplying ink from the outside to the common liquid chamber 108. The frame member 130 is fabricated by injection molding with use of, for example, a thermal setting resin (e.g. epoxy type resin) or polyphenylene sulfate.

The flow plate 101 is fabricated to form various concave parts and hole parts including the nozzle communication path 105 and the liquid chamber 106. The flow plate 101 is fabricated, for example, by using an anisotropic etching method in which an alkali type etching liquid (e.g. potassium hydroxide, KOH) is applied to a single crystal silicon substrate having a crystal plane orientation of (110). It is however to be noted that other materials may be used for fabricating the flow substrate 101 besides a single crystal silicon substrate. For example, a stainless steel substrate or a photosensitive resin may also be used.

The vibration plate 102 is fabricated, for example, by performing an electroforming method on a metal plate formed of nickel. It is however to be noted that other metal plates or a bonded member formed by bonding together a metal plate and a resin plate may also be used. The piezoelectric elements 121 and the pillar parts 123, and the frame member 130 are bonded to the vibration plate 102 by using an adhesive agent.

The nozzle plate 103 is formed with nozzles 104 having diameters ranging from 10 μm-30 μm in correspondence with the sizes of respective liquid chambers 106. The nozzle plate 103 is bonded to the flow plate 101 by using an adhesive agent. The nozzle plate 103 includes, for example, a metal material member having a water repellent layer formed on its outermost surface.

The piezoelectric element (in this example, PZT) 121 has a layered structure in which piezoelectric material 151 and internal electrodes 152 are alternately layered on top of one another as shown in FIG. 4. The internal electrodes 152, which are alternately extended to the side edge planes of the piezoelectric element 121, are connected to an independent electrode 153 and a common electrode 154. In this example, the pressure is applied to the ink in the liquid chamber 106 by using a piezoelectric constant d33 material for the piezoelectric material 151. It is however to be noted that pressure may also be applied to the ink in the liquid chamber 106 by using a piezoelectric constant d31 material for the piezoelectric material 151. Furthermore, a single row of piezoelectric elements 121 may be provided in correspondence with a single base substrate 121.

Accordingly, in a case of jetting ink (recording liquid) from the nozzles 104 of the above-described recording head 7, the piezoelectric element 121 is contracted by lowering the voltage applied to the piezoelectric element 121 to a voltage below a reference electric potential. Thereby, the volume of the liquid chamber 106 increases as the vibration plate 102 is lowered in correspondence with the contraction of the piezoelectric element 121. Then, ink flows into the liquid chamber 106. Then, the voltage applied to the piezoelectric element is raised so that the piezoelectric element 121 expands in the layered direction of the piezoelectric element 121. Thereby, the volume of the liquid chamber 106 decreases as the vibration plate 102 deforms in a manner protruding toward the nozzle 104 in correspondence with the expansion of the piezoelectric element 121. As a result, pressure is applied to the ink inside the liquid chamber 106, thereby jetting ink out from the nozzle 104.

Then, the position of the vibration plate 102 returns to its original position by lowering the voltage applied to the piezoelectric element 121 to the reference electric potential. As the vibration plate 102 returns to the original position, the liquid chamber 106 expands to create a negative pressure in the liquid chamber 106. The negative pressure in the liquid chamber 106 allows ink to be supplied into the liquid chamber 106 from the common liquid chamber 108. The recording operation of the recording head 7 moves on to the next ink jetting process after the vibration of the meniscus face of the nozzle 104 attenuates and becomes stable.

It is to be noted that the method of driving the recording head 7 is not limited to the above-described example (pull/push method). For example, a pull method or a push method may be employed by controlling the drive waveform applied to the recording head 7.

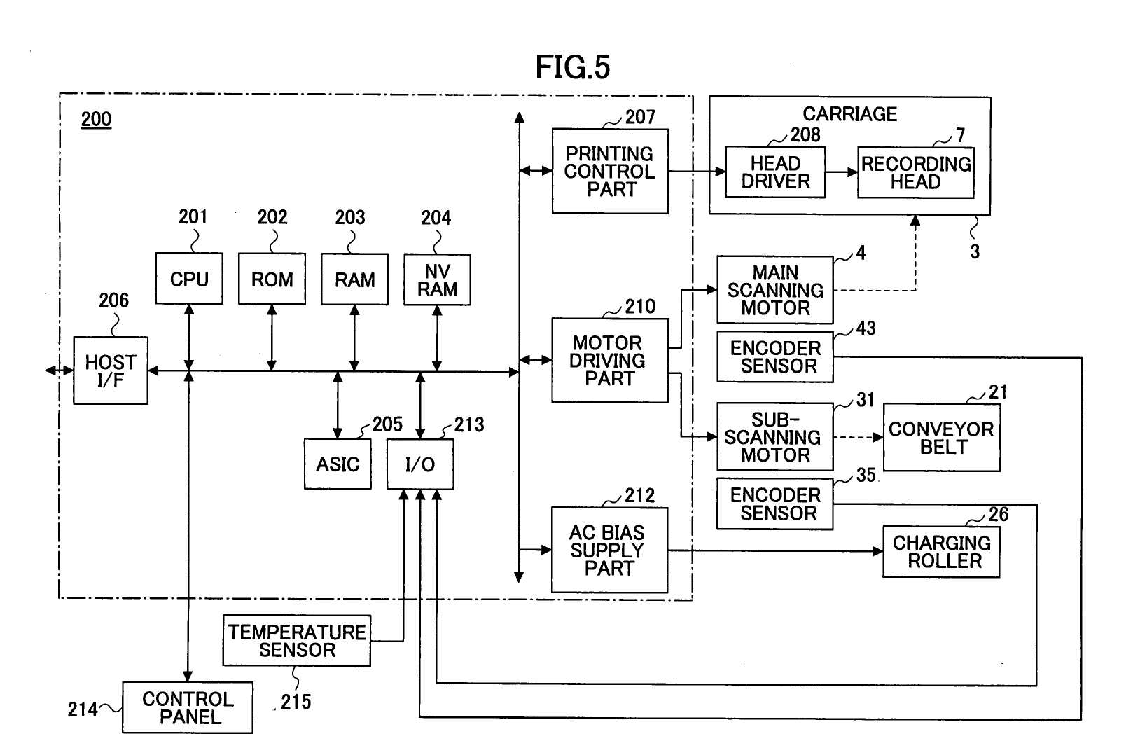

Next, an example of a control part 200 of the image forming apparatus 1000 is described with reference to FIG. 5.

The control part 200 includes, for example, a CPU 211 for overall control of the image forming apparatus 1000, a ROM 202 for storing programs executed by the CPU 211 and other data, a RAM for temporarily storing image data and the like, a rewritable non-volatile memory 204 for maintaining data when the power of the image forming apparatus 1000 is turned off, and an ASIC 205 for processing various signals corresponding to image data, input/output signals for performing image processing, and controlling various parts of the image forming apparatus 1000.

The control part 200 further includes, for example, an I/F 206 for exchanging data and signals with the host, a printing control part 207 including a data transfer part and a drive waveform generating part for controlling the recording head 7, a head driver (driver IC) 208 for driving the recording head 7 provided on the carriage 3, a motor driving part 210 for driving the main scanning motor 4 and the sub-scanning motor 31, an AC bias supply part 212 for supplying AC bias to the charge roller 34, and an I/O 213 for receiving various detection signals from the encoder sensors 43, 35, the temperature sensor 215, and other sensors. Moreover, the control part 200 is connected to a control panel 214 for inputting data to the image forming apparatus 1000 and displaying data.

The control part 200 receives data such as image data from the host side at the I/F 206 via a cable or a network (e.g., the Internet). The host side is connected to, for example, an information processing apparatus (e.g., a personal computer), an image reading apparatus (e.g., an image scanner) and/or a photographing apparatus (e.g., a digital camera).

The CPU 201 of the control part 200 reads out and analyzes the image data (printing data) stored in a reception buffer of the I/F 206. Then, the ASIC 205 performs various processes on the image data such as image processing and data rearrangement. Then, the processed image data are transferred from the printing control part (head drive control part) 207 to the head driver 208. It is to be noted that the generation of dot patterns for outputting images is conducted in the printer driver of the host side (described below).

The printer control part 207 transfers image data in the form of serial data to the head driver 208. In addition, the printer control part 207 outputs transfer clocks (required for transferring the image data), latch signals, and droplet control signals (mask signals) to the head driver 208. The printer control part 207 has a drive waveform generating part including a D/A converter for performing D/A conversion on pattern data of drive signals stored in the ROM 202 and a drive waveform selecting part for selecting the waveform to be output to the head driver 208. Accordingly, the printer control part 207 generates drive waveforms including one or more drive pulses (drive signals) and outputs the drive waveforms to the head driver 208.

The head driver 208 applies drive signals included in the waveforms output from the printer control part 207 to a driving element (e.g. the above-described piezoelectric element 121). The driving element generates energy for enabling ink droplets to be selectively jetted from the recording head 7. The head driver 208 applies the drive signals based on serially input image data corresponding to a single line of the recording head 7. By selecting the drive pulse included in the drive waveform, ink droplets of different sizes including large droplets (large dots), medium droplets (medium dots), and small droplets (small dots) can be jetted from the recording head 7.

The CPU 201 calculates the drive output value (control value) for controlling the main scanning motor 4 and drives the main scanning motor 4 via the motor driving part 210 in accordance with the calculated value. The calculation of the CPU 201 is based on the detected speed value and the detected position value obtained by sampling the detection pulses of the encoder sensor 43 (i.e. linear encoder) and the target speed value and the target position value stored beforehand in a speed/position profile. In the same manner, the CPU 201 calculates the drive output value (control value) for controlling the sub-scanning motor 31 and drives the sub-scanning motor 31 via the motor driving part 210 in accordance with the calculated value. The calculation of the CPU 201 is based on the detected speed value and the detected position value obtained by sampling the detection pulses of the encoder sensor 35 (i.e. rotary encoder) and the target speed value and the target position value stored beforehand in a speed/position profile.

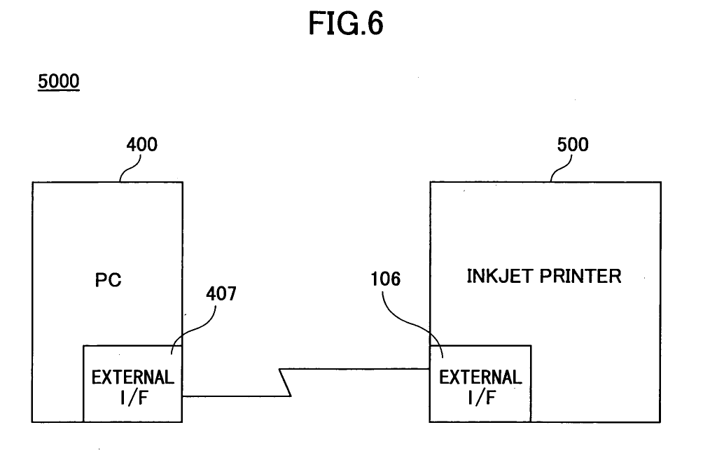

Next, an example of an image forming system 5000 according to an embodiment of the present invention is described with reference to FIG. 6. The image forming system 5000 includes the above-described image forming apparatus 1000 (in this example, indicated as an inkjet printer 500) and an image processing apparatus 400 (in this example, indicated as a personal computer (PC)). The image forming system 5000 has the PC (i.e. image processing apparatus) 400 and the inkjet printer (i.e. image forming apparatus) 500 connected via a predetermined interface or a network. One or more image processing apparatuses 400 may be connected to the image forming apparatus 500.

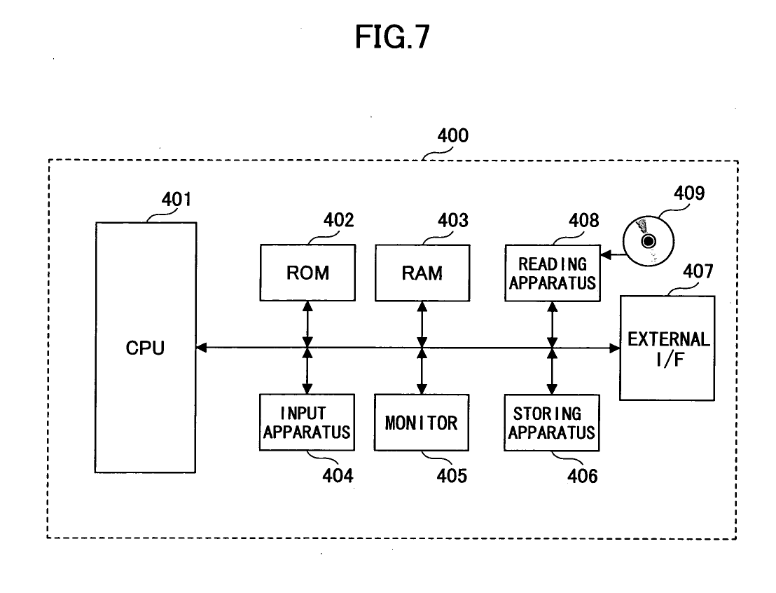

As shown in FIG. 7, the image processing apparatus 400 has, for example, a CPU 401, a ROM 402, and a RAM 403 connected with a bus line. Furthermore, the bus line is also connected with a storing apparatus 406 including a magnetic storage (e.g. hard disk), an input apparatus 404 (e.g., a mouse, a keyboard), a monitor 405 (e.g., a LCD, a CRT), and a recording medium reading apparatus 408 that reads out data from a computer-readable recording medium (e.g., an optical disk). Moreover, the bus line is also connected with a predetermined interface (external I/F) 407 for transmitting and receiving data with outside networks (e.g., the Internet) and outside devices (e.g., a USB).

A program including an image processing program according to an embodiment of the present invention is stored in the storing apparatus 406 of the image processing apparatus 400. The image processing program may be installed in the storing apparatus 406 by reading out the program from a computer-readable recording medium 409 via the reading apparatus 408 or by downloading the program from an outside network (e.g., the Internet) via the external I/F 407. By installing the program in the storing apparatus 406, the image processing apparatus 400 can perform the below-described image processing method (image processing operation) according to an embodiment of the present invention. The program may operate on a given operating system (OS). Furthermore, the program may be part of a given application software package.

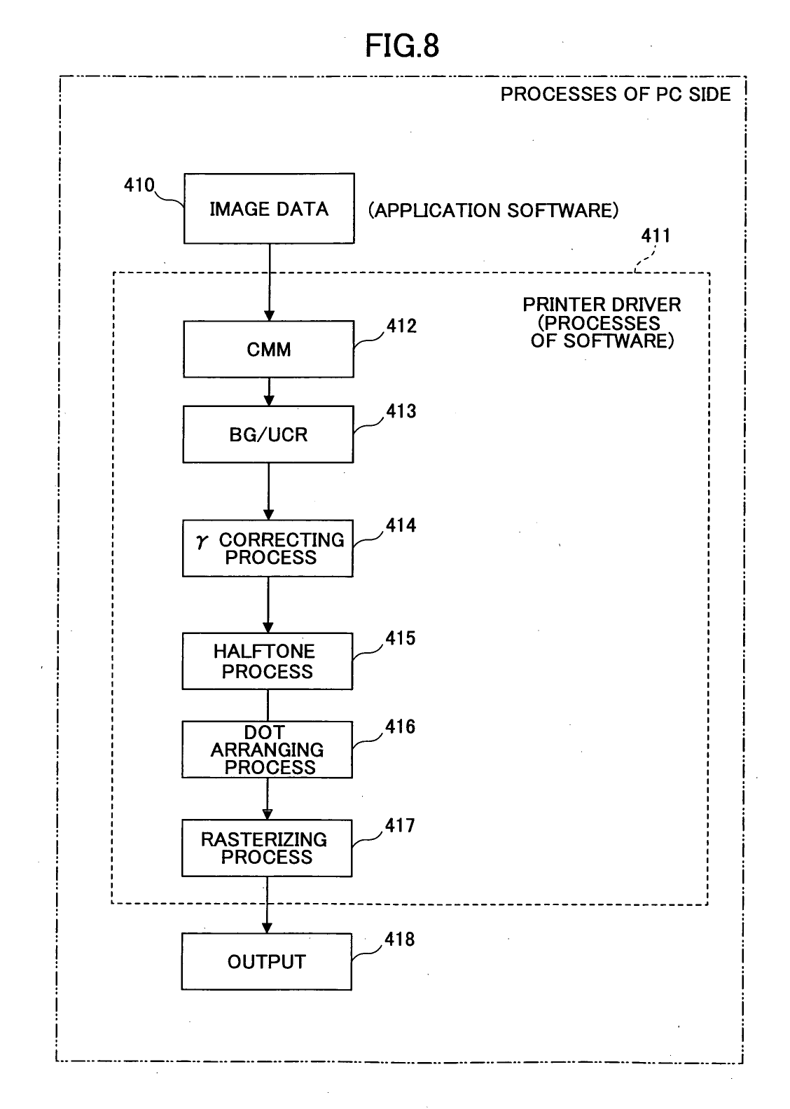

Next, an example of executing an image processing method of the present invention with the program installed in the image processing apparatus 400 is described with reference to FIG. 8. This example is a case where most of the steps (processes) of the image processing method are conducted by the image processing apparatus (PC side) 400. This example is preferable when a relatively low cost inkjet printer is used.

A printer driver 411, which is included in the program installed in the image processing apparatus 400, performs various processes on image data obtained from, for example, an application software program. The printer driver 411 includes, for example, a CMM (Color Management Module) process part 412, a BG/UCR (Black Generation/Under Color Removal) process part 413, a γ correction process part 414, a halftone process part 415, a dot arrangement process part 416, and a rasterizing part 417. The CMM process part 412 is for converting the color space of the obtained image data from a color space for display on a monitor to a color space for image formation with an image forming apparatus, in other words, conversion from the RGB color system to the CMY color system. The BG/UCR process part 413 is for generating black or removing under color with respect to the values of C, M, and Y. The γ correction part 414 is for correcting input/output image data in accordance with the property of the image forming apparatus or the preferences of the user. The halftone process part 415 is for performing a halftone process on the image data. The dot arrangement part 416 is for displacing the arrangement of the dot pattern jetted from the image forming apparatus 500 in a predetermined order in accordance with the results of the halftone process (this process may be performed as part of the halftone process). The rasterizing part 417 is for converting the printing image data (dot pattern data) obtained by the halftone process and the dot arrangement process to image data corresponding to each position (location) of the nozzles of the image forming apparatus 500. As a result, the converted image data of the rasterizing part 417 is output to the image forming apparatus (inkjet printer 500).

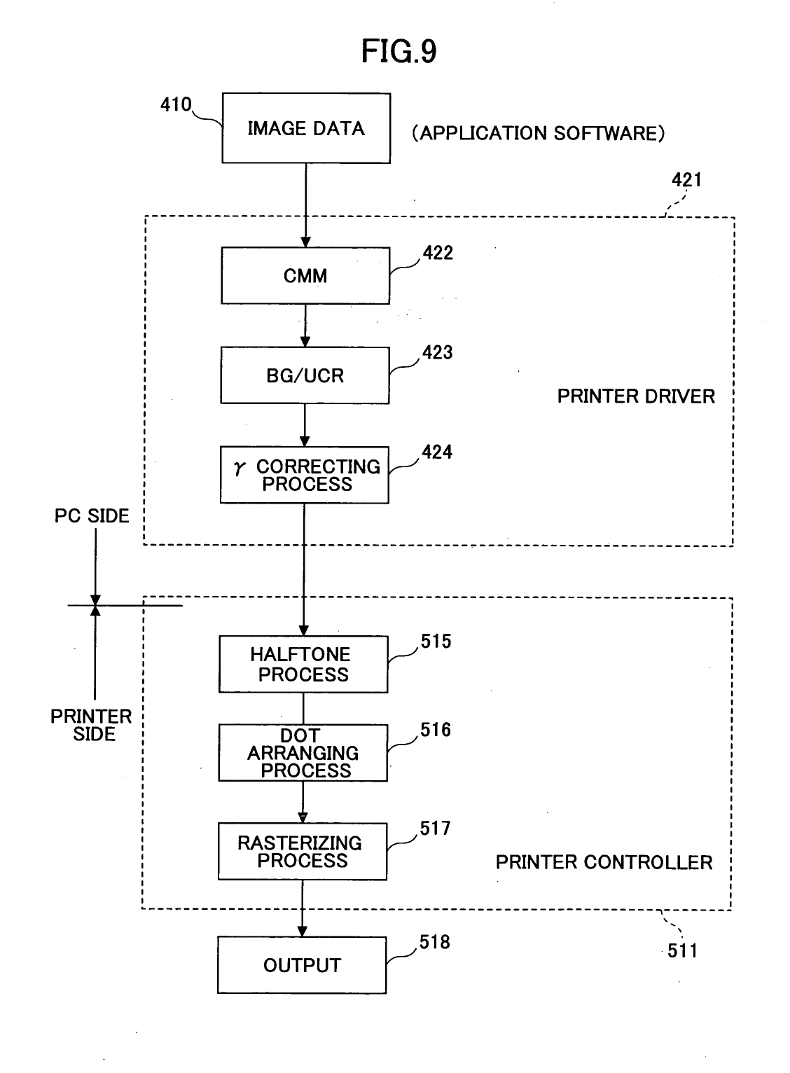

Next, an example of executing an image processing method of the present invention with the program installed in the image processing apparatus 400 is described with reference to FIG. 8. Next, an example of conducting part of the steps (processes) of the image processing method with the image forming apparatus 500 is described with reference to FIG. 9. This example is preferable when a relatively high cost inkjet printer is used since the processes of the method can be executed at high speed.

The printer driver 421 in the image processing apparatus (PC side) 400 includes, for example, a CMM (Color Management Module) process part 422 for converting the color space of the obtained image data from a color space for display on a monitor to a color space for image formation with an image forming apparatus (i.e. conversion from the RGB color system to the CMY color system), a BG/UCR (Black Generation/Under-Color Removal) process part 423 for generating black or removing under color with respect to the values of C, M, and Y, and a γ correction process part 424 for correcting input/output image data in accordance with the properties of the image forming apparatus or the preferences of the user. The corrected image data generated by the γ correction process part 424 are output to the image forming apparatus (inkjet printer) 500.

The printer controller 511 (control part 200) in the image forming apparatus 500 includes a halftone process part 515 for performing a halftone process on the image data, a dot arrangement process part 516 for displacing the arrangement of the dot pattern jetted from the image forming apparatus 500 in a predetermined order in accordance with the results of the halftone process (this process may be performed as part of the halftone process), and a rasterizing part 517 for converting the printing image data (dot pattern data) obtained by the halftone process and the dot arrangement process to image data corresponding to each position (location) of the nozzles of the image forming apparatus 500. As a result, the converted image data of the rasterizing part 417 are output to the printing control part 207.

The image processing method of the present invention can be suitably applied to both the configurations shown in FIGS. 8 and 9. The image processing method is described below by using the configuration shown in FIG. 8 where the image forming apparatus (printer side) does not have the function of generating dot patterns in accordance with an inside command (command from a part inside the image forming apparatus) for printing images or letters (characters). That is, in the example below, a printing command from application software of the image processing apparatus (which is the host) 400 is executed by processing an image with a printer driver 411, generating multi-value dot pattern data that can be output by the image forming apparatus (image data for printing), rasterizing the image data, transferring the rasterized image data to the image forming apparatus 500, and printing the image data with the image forming apparatus 500.

More specifically, in the image processing apparatus 400, printing commands, including information on the position, thickness and the shape of the lines that are to be printed, from application software or the operating system are temporarily stored in an image data memory, along with information on the type of character, size, and the position of the letters that are to be printed. It is to be noted that the commands ate in a predetermined printing language.

The commands stored in the image data memory are interpreted by the rasterizer part. If the command is for depicting (printing) a line, image data are converted into a dot pattern in correspondence with, for example, the position and thickness designated by the command. If the command is for depicting (printing) a letter, corresponding data are extracted from font outline data stored inside the image processing apparatus (host computer) 400, so that image data are converted into a dot pattern in correspondence with, for example, the position and size designated by the command.

Then, various image processes are performed on the data of the dot pattern (image data 410). The image processed data are stored in a raster data memory. The image processing apparatus 400 rasterizes the data of the dot pattern based on an orthogonal grid indicating a basic printing position. The various image processes include, for example, a color management process (CMM), γ correction process, a halftone process (e.g. a dither method, an error diffusion method), an undertone removal process, and a total ink amount controlling process. Then, the rasterized data are transferred to the image forming apparatus 500 via an interface.

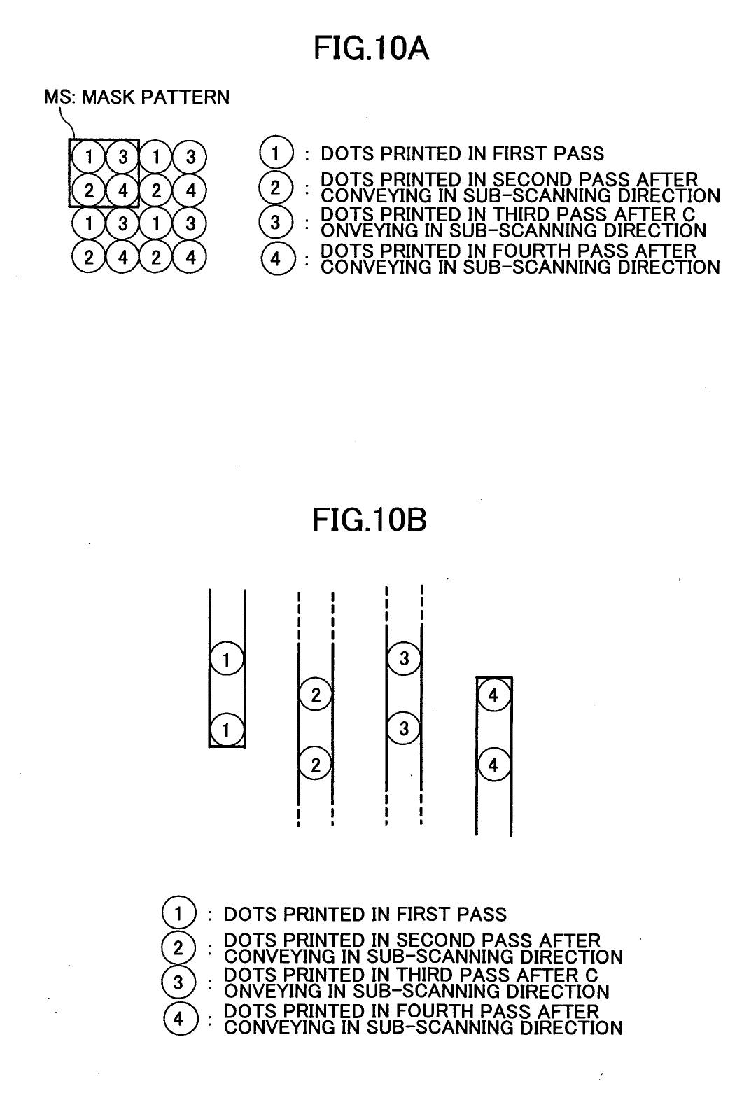

Next, a relationship between a halftone process and dot arrangement is described with reference to FIGS. 10A-20.

The order of dots formed by combining a multi-pass method and an interlace method can be arranged in the form of a matrix as shown in FIG. 10A. The multi-pass method is a method of forming images by scanning a group of nozzles or different groups of nozzles in a main scanning direction with respect to a same area on a sheet of paper plural times. The interlace method is a method of forming images by scanning in a main scanning direction with respect to a same area on a sheet of paper for plural number of times while adjusting the amount of conveying the paper in the sub-scanning direction (interlace scanning). This matrix may be referred to as a mask pattern (recording sequence matrix).

In a case where the mask pattern shown in FIG. 10A is used, the dots enumerated with the number “1” are the dots that are printed in the first pass (see FIG. 10B). Likewise, the dots enumerated with the number “2” are dots that are printed in the second pass after the paper is conveyed (advanced) in the sub-scanning direction, the dots enumerated with the number “3” are dots that are printed in the third pass after the paper is further conveyed (advanced) in the sub-scanning direction, and the dots enumerated with the number “4” are dots that are printed in the fourth pass after the paper is conveyed (advanced) in the sub-scanning direction.

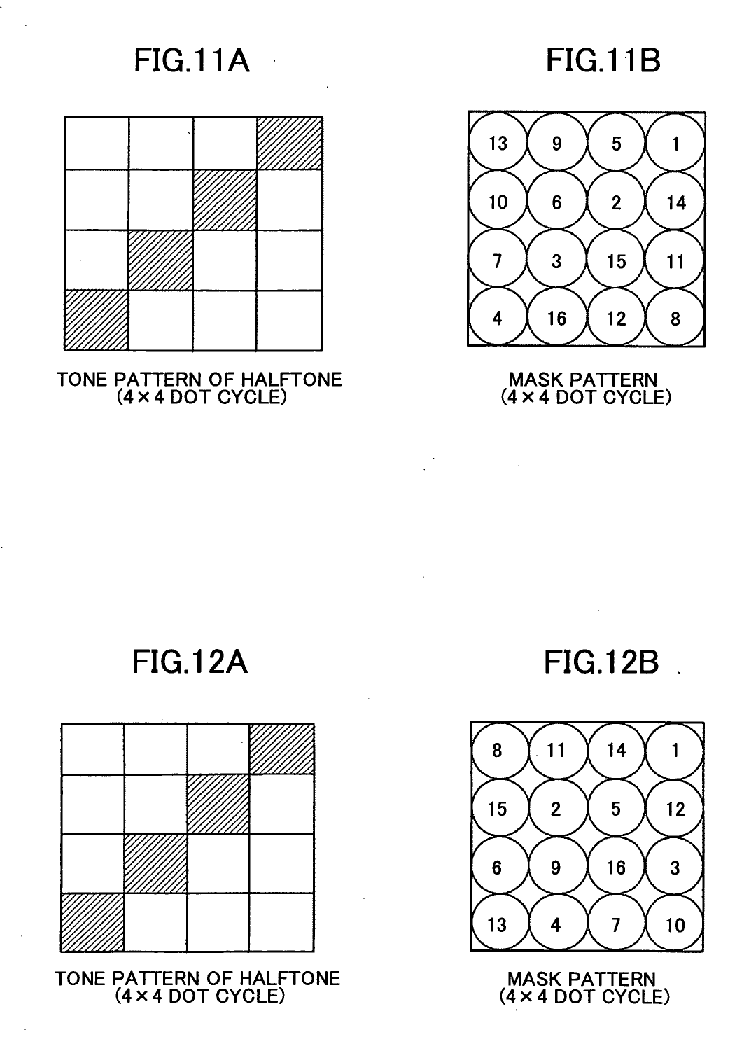

In a comparative example, a halftone pattern (matrix pattern) shown in FIG. 11A is used for forming a diagonal line tone (dots shaded with diagonal lines in FIG. 11A) in a 4×4 dot cycle, and a pattern shown in FIG. 11B is used for printing dots by scanning the recording head sixteen times (sixteen passes) in accordance with the dots 1-16 while conveying the paper in the sub-scanning direction for 15 times.

In the comparative example, the four dots which form the diagonal line of the halftone pattern are printed consecutively by making four passes (first-fourth pass). That is, in forming a single line tone by consecutively scanning in the main scanning direction, the printing of the line tone can be achieved by performing the main scanning movement only four times among the total of sixteen passes repeated in the main scanning movement.

However, there are some cases where the impact position of the droplets deviates from a target image forming area due to factors such as the position of the nozzles, the main scanning movement, or the sub-scanning movement when moving the recording head and jetting ink (recording liquid) therefrom.

Accordingly, in the comparative example where a line image comprising four orderly arranged dots is formed (printed) by consecutively moving the recording head in the main scanning direction four times (first-fourth scan) and not forming (printing) any dots in the subsequent scanning in the main scanning direction (fifth-sixteenth scan), there will be a considerable deviation in the impact position of droplets in a case where there is an inconsistency during the first-fourth scans in the main scanning directions. This results to problems such as printing irregularity and banding.

Meanwhile, according to an embodiment of the present invention, in a case of forming images by employing a multi-pass method and forming the images with a halftone method in which dots are arranged in a predetermined order, image data are generated so that the orderly arranged dots (dot arrangement) can be formed by making passes in an inconsecutive order. In other words, instead of forming an image by using a mask pattern that forms the image by scanning the recording head in the main scanning direction in consecutive order, the embodiment of the present invention forms an image by using a mask pattern that forms the image by scanning the recording head in the main scanning direction in an inconsecutive order. Thereby, even in a case where there occurs deviation in the impact position of the droplets with respect to the target image forming area, the deviated areas of a given line can be decentralized or evened out. This reduces the probability of printing irregularity and banding.

In the example of the present invention, a halftone pattern (matrix pattern) shown in FIG. 12A is used for forming a diagonal line tone (dots shaded with diagonal lines in FIG. 12A) in a 4×4 dot cycle, and a pattern shown in FIG. 12B is used for printing dots by scanning the recording head in the main scanning direction sixteen times (sixteen passes) in accordance with the dots 1-16 while conveying the paper in the sub-scanning direction 15 times. In the mask pattern shown in FIG. 12B, the dots with the numbers 1, 5, 9, and 13 correspond to the dots comprising the line tone of the halftone pattern shown in FIG. 12A.

Accordingly, the four dots in the line tone of the halftone pattern are printed by the inconsecutive passes including the first pass, the fifth pass, the ninth pass, and the thirteenth pass. Thus, even in a case where there occurs deviation in the impact position of the droplets with respect to the target image forming area, the deviated impact points can be decentralized (scatter) or evened out with the inconsecutive first pass, fifth pass, ninth pass, and thirteenth pass. This reduces the probability of printing irregularity and banding.

Next, the scattering of dots for forming the tone is defined by the degree of scattering obtained from the below formula.
Degree of Scattering=Σ (main scan interval during dot forming operation−average interval)²/number of scans for forming a tone pattern [Formula 1]

In obtaining the degree of scattering in a case of using the mask pattern shown in FIG. 11B for forming dots of a tone, the interval of scanning in the main scanning direction is “1” between the first and second pass, the second and third pass, and the third and fourth pass, respectively. The interval between the fourth and first pass is “13”. Furthermore, the average of the intervals of scanning in the main scanning direction is “4 ({1+1+1+13}/4”), and the number of scans in the main direction for forming the tone is also “4”. Therefore, as shown in the below Formula 2, the obtained degree of scattering for forming a tone is “27”.
{(1−4)²+(1−4)²+(1−4)²+(13−4)²}/4=27 [Formula 2]

Meanwhile, in obtaining the degree of scattering in a case of using the mask pattern shown in FIG. 12B for forming dots of a tone, the interval of scanning in the main scanning direction is “4” between the first and fifth pass, the fifth and ninth pass, the ninth and thirteenth pass, and the thirteenth and first pass, respectively. Furthermore, the average of the intervals of scanning in the main scanning direction is “4 ({4+4+4+4}/4”), and the number of scans in the main direction for forming the tone is also “4”. Therefore, as shown in the below Formula 3, the obtained degree of scattering for forming a tone is “0”.
{(4−4)²+(4−4)²+(4−4)²+(4−4)²}/4=0 [Formula 3]

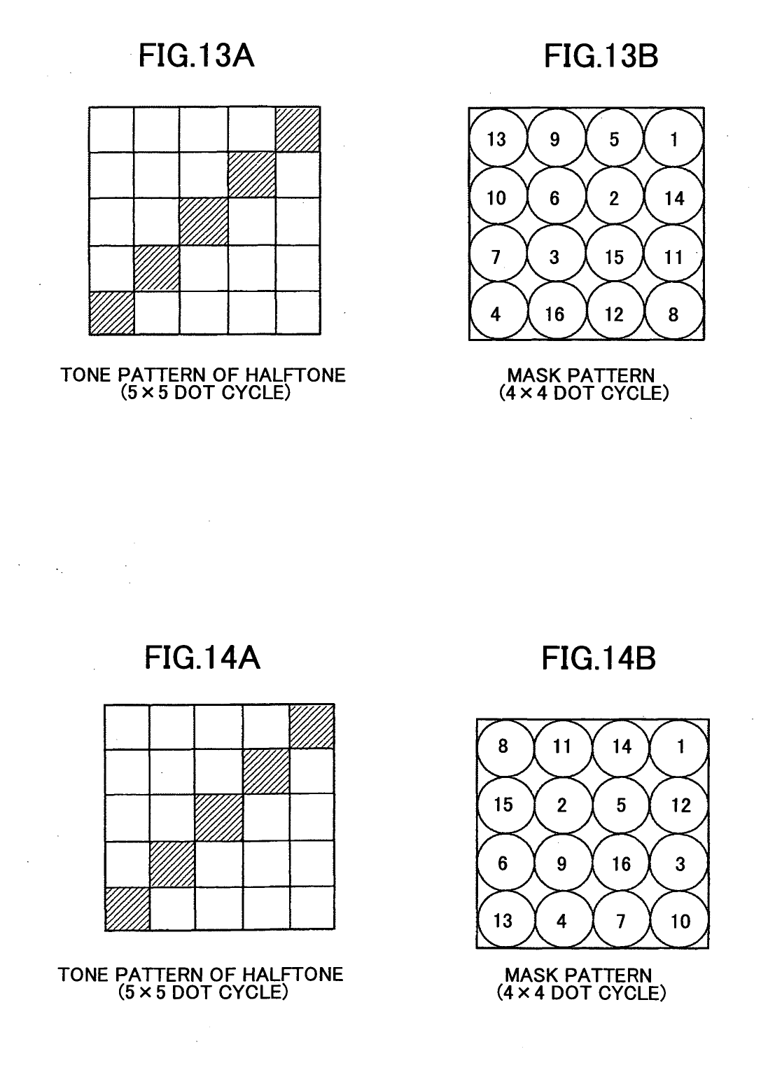

Next, another embodiment of the present invention is described with reference to FIGS. 13A and 13B. In this embodiment, the size of the halftone pattern and the size of the mask pattern are different, in which the halftone pattern shown in FIG. 13A has a size of 5×5 dots (i.e. ⅕ tone) and the mask pattern shown in FIG. 13B has a size of 4×4 dots. The dot arrangement of the pattern is the same as that shown in FIG. 11B (that is, the dot arrangement is consecutive).

In this embodiment, since the halftone pattern which is used for the halftone process and the mask pattern which defines the dot arrangement order based on the halftone process results have different sizes, printing is performed on each scanning line in the main scanning direction. Therefore, deviation of impact positions can be evened out for the entire image area. This reduces the probability of printing irregularity and banding compared to that shown in the FIG. 11A.

Accordingly, by determining the order of arranging the dots by simply using the mask pattern having a size different from the halftone pattern used for a halftone process, the dots comprising the tone can be formed by making passes in an inconsecutive order. Hence, deviation of impact positions can be evened out for the entire image area. This reduces the probability of printing irregularity and banding compared to that shown in the FIG. 11A.

Next, another further embodiment of the present invention is described with reference to FIGS. 14A and 14B. In this embodiment, in addition to providing the halftone pattern and the mask pattern in different sizes, the order of the dot arrangement of the mask pattern is different from that shown in FIG. 11B. That is, in addition to providing the halftone pattern shown in FIG. 14A with a size of 5×5 dots (i.e. ⅕ tone) and the mask pattern shown in FIG. 14B with a size of 4×4 dots, the dot arrangement of the mask pattern is adjusted so that the degree of scattering of a single tone pattern can be reduced. By reducing the degree of scattering of the single tone, the deviation of impact position can be decentralized and evened out.

Accordingly, with this embodiment, the dot arrangement of the mask pattern is adjusted so that the degree of scattering of a single tone pattern can be reduced. In addition, as described above, since the halftone pattern which is used for the halftone process and the mask pattern which defines the dot arrangement order based on the halftone process results have different sizes, printing can be performed on each scanning line in the main scanning direction. Therefore, deviation of impact positions can be evened out for the entire image area. Hence, printing irregularity and banding can be effectively reduced.

In the above-described embodiments of the present invention, the size of the mask pattern is 4×4. This size enables printing in a 4 pass ¼ interlace. That is, the printing method (printing order) indicated by the 4×4 mask pattern (i.e. 4 pass ¼ interlace) can even out the scattering of the impact position with respect to the entire image in a case of a ⅕ tone, to thereby improve image quality.

Furthermore, the deviation of impact position can be evened out also for a mask pattern of a size other than the above-described size by adjusting the mask pattern or altering the tone pattern.

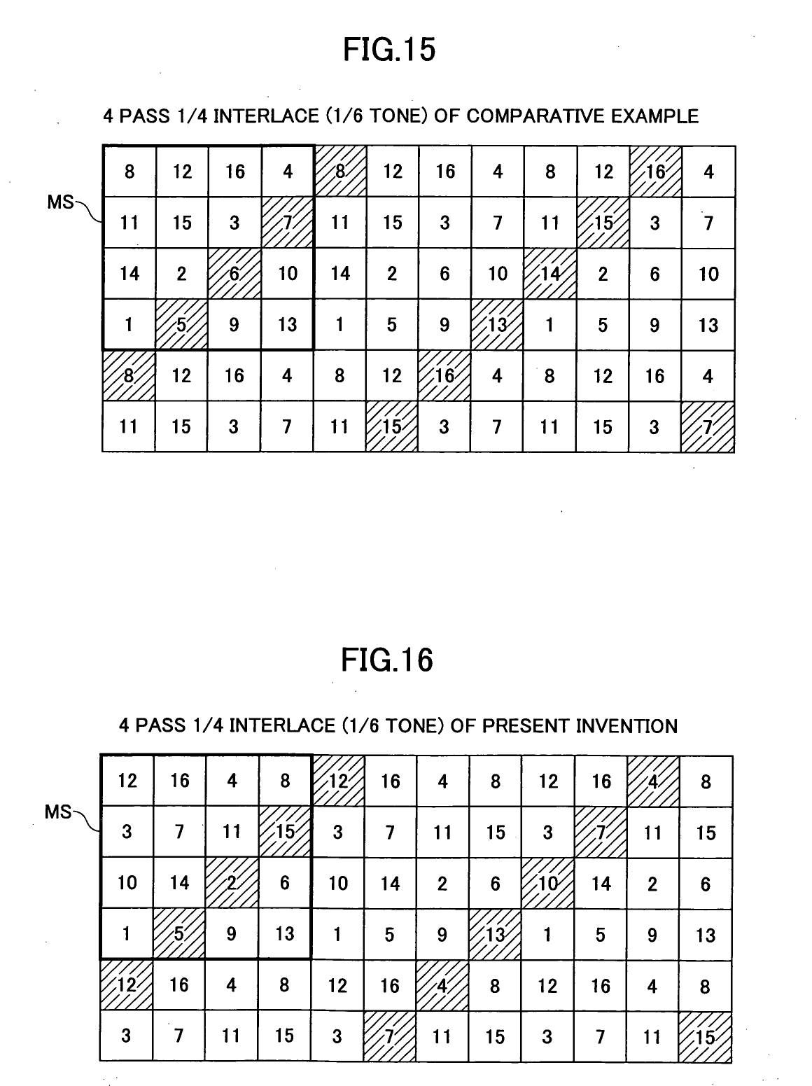

Next, a comparative example and an example of the present invention for a 4 pass ¼ interlace (⅙ tone) is described with reference to FIGS. 15A-16B. In each of the drawings, the dots shaded with diagonal lines indicate a tone line, and the frame indicated as MS indicates a mask pattern.

In calculating the degree of scattering of a single tone pattern of a comparative example shown in FIG. 15, the order of printing the tone pattern is . . . 5-6-7-8-5 . . . ; the respective amount of conveying the paper in the sub-scanning direction is 1, 1, 1, and 13; the average interval of conveying the paper in the sub-scanning direction is 4; and the number of scanning in the main scanning direction (scan number) is 4. By applying these values to the above-described Formula 1, the degree of scattering becomes 27. In calculating the degree of scattering of the entire image of the comparative example shown in FIG. 15: the order of printing the entire image is . . . 16-5-6-7-8-13-14-15-16-5 . . . ; the respective amount of conveying the paper in the sub-scanning direction is 5, 1, 1, 1, 5, 1, 1, 1, and 5; the average interval of conveying the paper in the sub-scanning direction is 2; and the number of scanning in the main scanning direction (scan number) is 8. By applying these values to the above-described Formula 1, the degree of scattering becomes 3.

In calculating the degree of scattering of a single tone pattern of an example of the present invention shown in FIG. 16, the order of printing the tone pattern is . . . 2-5-12-15-2 . . . ; the respective amount of conveying the paper in the sub-scanning direction is 3, 7, 3, and 3; the average interval of conveying the paper in the sub-scanning direction is 4; and the number of scanning in the main scanning direction (scan number) is 4. By applying these values to the above-described Formula 1, the degree of scattering becomes 3. In calculating the degree of scattering of the entire image of the example of the present invention shown in FIG. 16: the order of printing the entire image is . . . 15-2-4-5-7-10-12-13-15-2 . . . ; the respective amount of conveying the paper in the sub-scanning direction is 3, 2, 1, 2, 3, 2, 1, 2, and 3; the average interval of conveying the paper in the sub-scanning direction is 2; and the number of scanning in the main scanning direction (scan number) is 8. By applying these values to the above-described Formula 1, the degree of scattering becomes 0.5.

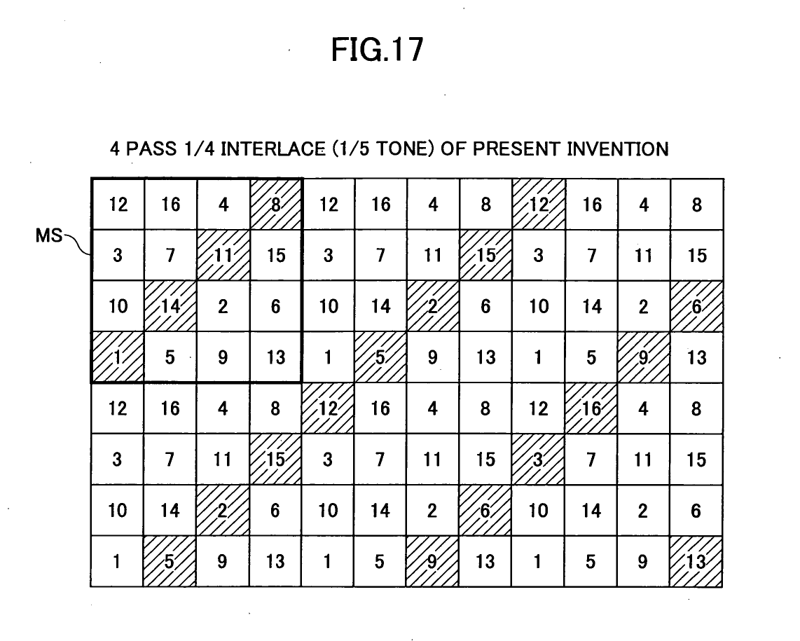

Next, another example of the present invention for a 4 pass ¼ interlace (⅕ tone) is described with reference to FIG. 17. In calculating the degree of scattering of a single tone pattern of the example of the present invention shown in FIG. 17, the order of printing the tone pattern is . . . 1-8-11-14-1 . . . ; the respective amount of conveying the paper in the sub-scanning direction is 7, 3, 3 and 3; the average interval of conveying the paper in the sub-scanning direction is 4; and the number of scanning in the main scanning direction (scan number) is 4. By applying these values to the above-described Formula 1, the degree of scattering becomes 3. In calculating the degree of scattering of the entire image of the example of the present invention shown in FIG. 17: the order of printing the entire image is . . . 16-1-2-3-4-5-6-7-8-9-10-11-12-13-14-15-16-1 . . . ; the amount of conveying the paper in the sub-scanning direction is always 1; the average interval of conveying the paper in the sub-scanning direction is 1; and the number of scanning in the main scanning direction (scan number) is 16. By applying these values to the above-described Formula 1, the degree of scattering becomes 0.

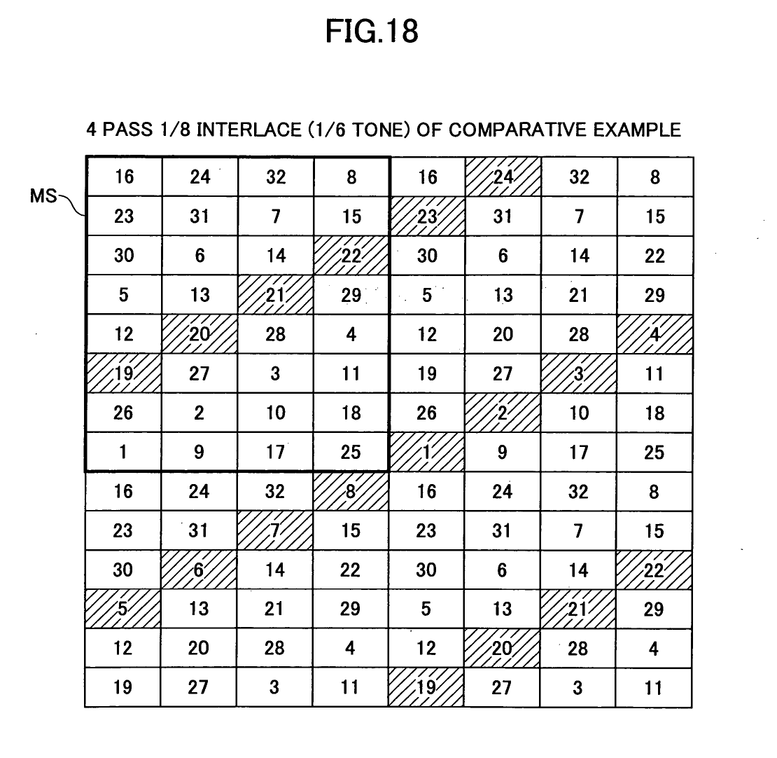

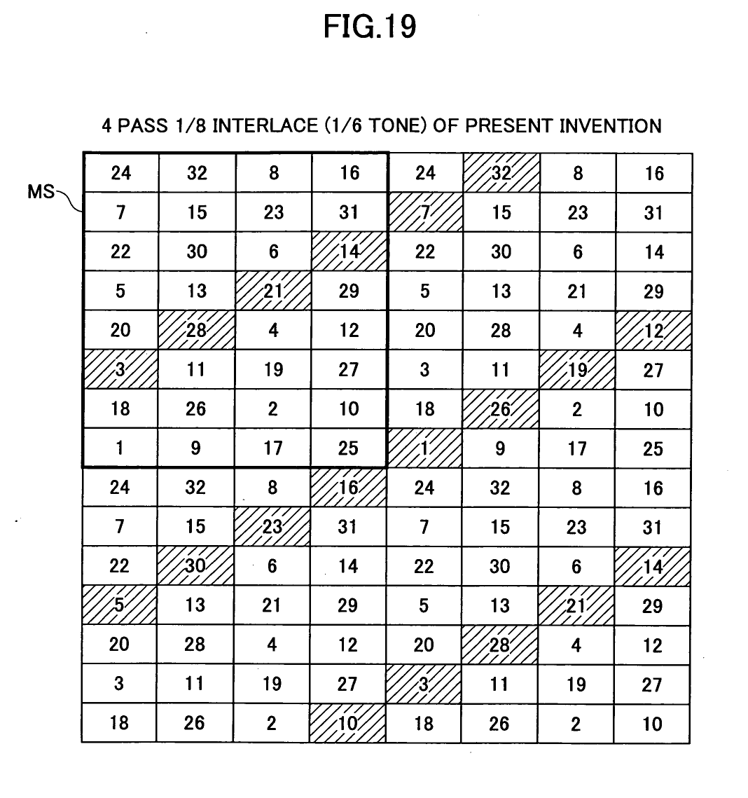

Next, a comparative example and an example of the present invention for a 4 pass ⅛ interlace (⅙ tone) is described with reference to FIGS. 18-19.

In calculating the degree of scattering of a single tone pattern of a comparative example shown in FIG. 18, the order of printing the tone pattern is . . . 1-2-3-4-5-6-7-8-1 . . . ; the respective amount of conveying the paper in the sub-scanning direction is 1, 1, 1, 1, 1, 1, 1, and 24; the average interval of conveying the paper in the sub-scanning direction is 4; and the number of scanning in the main scanning direction (scan number) is 8. By applying these values to the above-described Formula 1, the degree of scattering becomes 57.875. In calculating the degree of scattering of the entire image of the comparative example shown in FIG. 18, the order of printing the entire image is . . . 24-12-3-4-5-6-7-8-17-18-19-20-21-22-23-24-1 . . . ; the respective amount of conveying the paper in the sub-scanning direction is 9, 1, 1, 1, 1, 1, 1, 1, 9, 1, 1, 1, 1, 1, 1, 1, and 9; the average interval of conveying the paper in the sub-scanning direction is 2; and the number of scanning in the main scanning direction (scan number) is 16. By applying these values to the above-described Formula 1, the degree of scattering becomes 7.

In calculating the degree of scattering of a single tone pattern of an example of the present invention shown in FIG. 19, the order of printing the tone pattern is . . . 1-5-12-16-19-23-26-30-1 . . . ; the respective amount of conveying the paper in the sub-scanning direction is 4, 7, 4, 3, 4, 3, 4, and 3; the average interval of conveying the paper in the sub-scanning direction is 4; and the number of scanning in the main scanning direction (scan number) is 8. By applying these values to the above-described Formula 1, the degree of scattering becomes 1.5. In calculating the degree of scattering of the entire image of the example of the present invention shown in FIG. 19, the order of printing the entire image is . . . 32-1-3-5-7-10-12-14-16-17-19-21-23-26-28-30-32-1 . . . ; the respective amount of conveying the paper in the sub-scanning direction is 1, 2, 2, 2, 3, 2, 2, 2, 1, 2, 2, 2, 3, 2, 2, 2, and 1; the average interval of conveying the paper in the sub-scanning direction is 2; and the number of scanning in the main scanning direction (scan number) is 16. By applying these values to the above-described Formula 1, the degree of scattering becomes 0.25.

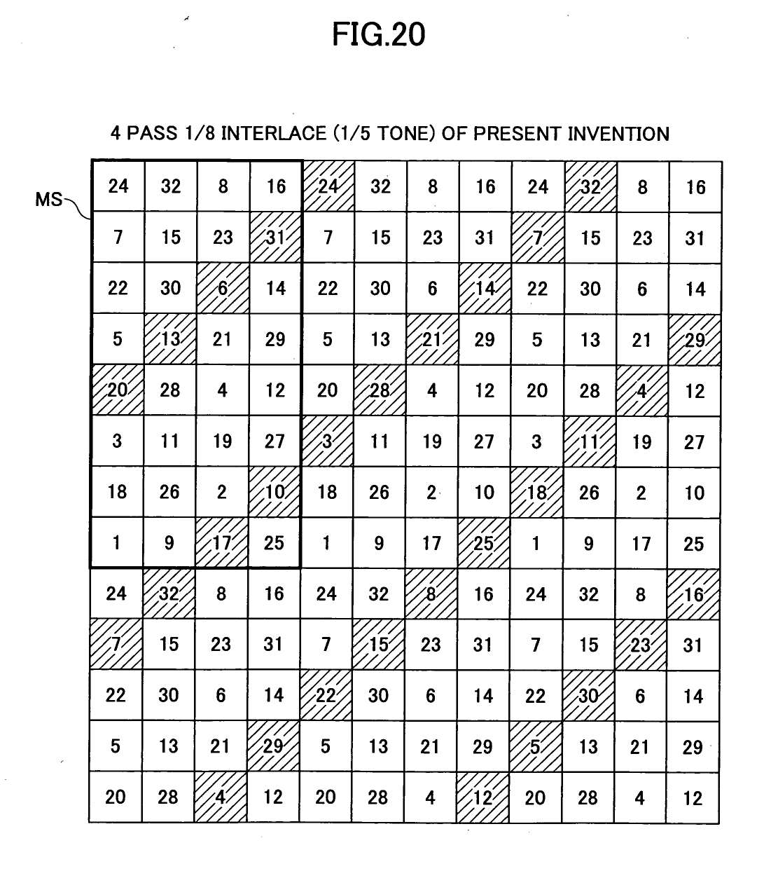

Next, another example of the present invention for a 4 pass ⅛ interlace (⅕ tone) is described with reference to FIG. 20. In calculating the degree of scattering of a single tone pattern of the example of the present invention shown in FIG. 20, the order of printing the tone pattern is . . . 1-5-12-16-19-23-26-30-1 . . . ; the respective amount of conveying the paper in the sub-scanning direction is 4, 7, 4, 3, 4, 3, 4, and 3; the average interval of conveying the paper in the sub-scanning direction is 4; and the number of scanning in the main scanning direction (scan number) is 5. By applying these values to the above-described Formula 1, the degree of scattering becomes 1.5. In calculating the degree of scattering of the entire image of the example of the present invention shown in FIG. 20: the order of printing the entire image is . . . 32-1-2-3-4-5-6-7-8-9-10-11-12-13-14-15-16-17-18-19-20-21-22-23-24-25-26-27-28-29-30-31-32-1 . . . ; the amount of conveying the paper in the sub-scanning direction is all 1; the average interval of conveying the paper in the sub-scanning direction is 1; and the number of scanning in the main scanning direction (scan number) is 16. By applying these values to the above-described Formula 1, the degree of scattering becomes 0.

Although the above-described embodiments of the present invention are explained by using an example of a printer driver (program) for enabling an image processing apparatus (computer) to execute the image processing method of the present invention, the image forming apparatus may include a component or a program for executing the image processing method of the present invention. Moreover, the image forming apparatus may include an ASIC (Application Specific Integrated Circuit) for executing the image processing method of the present invention.

Although the above-described embodiments of the present invention are explained by using an example where the image processing method is executed by employing a mask pattern for moving the recording head in the main scanning direction in an inconsecutive order when forming the arrangement of dots on the recording medium, the method may be executed by modifying the halftone pattern (matrix pattern) used in the halftone process for allowing the recording head to move in the main scanning direction in an inconsecutive order when forming the arrangement of dots on the recording medium.

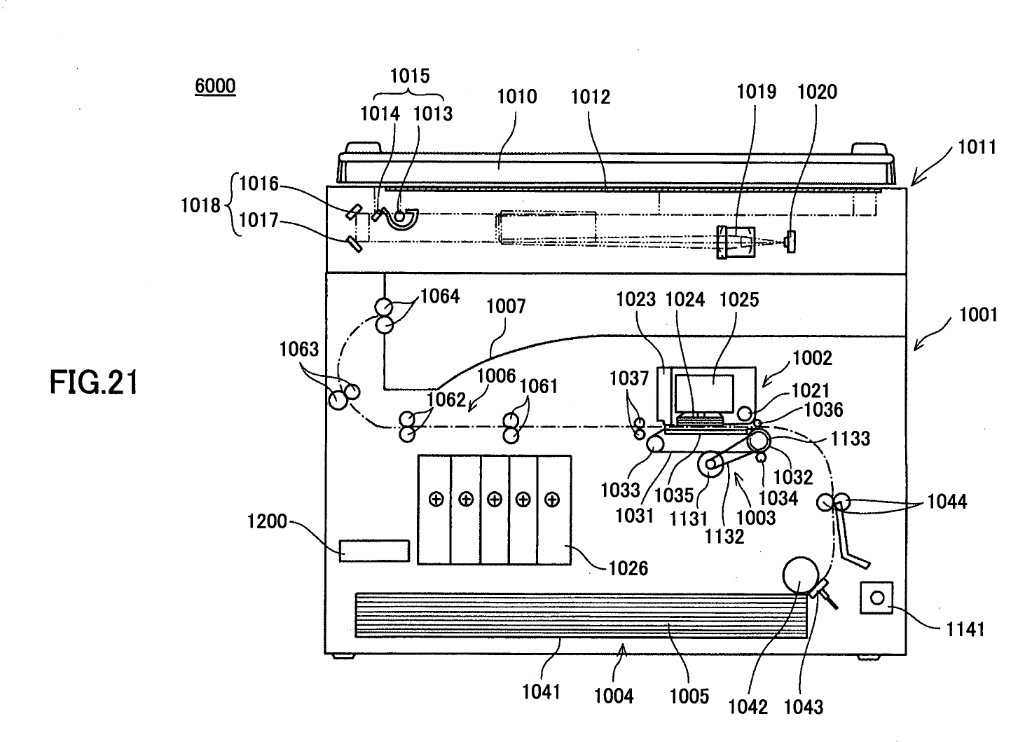

Next, an image forming apparatus 6000 according to another embodiment of the present invention is described with reference to FIG. 21. The image forming apparatus in this embodiment is a multifunction machine including the functions of an inkjet recording apparatus and a copying function.

The image forming apparatus 6000 has a main body 1001 installed with, for example, an image forming part 1002 and a sub-scan paper conveying part 1003 (the combination of the two parts 1002 and 1003 may also be referred to as “printer engine unit”). A sheet feeding part 1004 is provided at a bottom part of the main body 1001 for feeding a recording medium (paper) 1005 sheet by sheet. Then, the sub-scan paper conveying part 1003 conveys the recording medium 1005 from the sheet feeding part 1004 to the image forming part 1002. Then, the image forming part 1002 forms (records) images on the recording medium 1005 by jetting ink droplets onto the recording medium 1005. Then, a sheet discharging part 1006 discharges the recording medium 1005 on a sheet discharge tray 1007 provided on an upper surface of the main body 1001.

Furthermore, the image forming apparatus 6000 includes an image reading part 1001 disposed on an upper part of the sheet discharge tray 1007. The image reading part (scanner part) 1001 serves as a system for inputting image data (print data) to be used for forming images in the image forming part 1002. The image reading part 1001 includes a scanning optical system 1015 having a light source 1013 and a mirror 1014 and another scanning optical system 1018 having mirrors 1016 and 1017. The scanning optical systems 1015 and 1018 are moved across a contact glass 1012 for scanning an image from an original document placed on the contact glass 1012. An image reading element 1020, which is disposed behind a lens 1019, reads image signals obtained by scanning the original document. The read image signals are digitized and are formed into print data by performing an image processing operation on the image signals. Then, the print data is printed onto a recording medium. It is to be noted that a pressing plate 1010 is provided above the contact glass 1012 for holding the original document placed on the contact glass 1012.

Moreover, the image forming apparatus 6000 may also obtain print data from external apparatuses such as an image processing apparatus (e.g. PC), an image reading apparatus (e.g. image scanner), or a photographing apparatus (e.g. digital camera) that are connected to the image forming apparatus 6000 via a cable or a network, for example.

Similar to the above-described image forming apparatus (inkjet recording apparatus) 1000, the image forming part 1002 has a recording head 1024 mounted on a movable carriage 1023. A guiding rod 1021 guides the carriage 1023 in a main scanning direction that perpendicularly intersects a paper conveying direction (sub-scanning direction). The recording head 1024 has one or more liquid jetting head parts provided with an array of nozzles for jetting ink droplets of various colors to the recording medium 1005. The image forming part 1002 employs a shuttle type recording method (shuttle type recording head) in which ink droplets are jetted to the recording medium 1005 while the carriage 1023 is moved in the main scanning direction by a carriage scan mechanism (not shown) and the recording medium 1005 is conveyed in the sheet conveying direction (sub-scanning direction) by the sub-scan sheet conveying part 1003. It is to be noted that the image forming part 1002 may alternatively employ a line type recording method which uses a line type recording head.

The recording head 1024 has a nozzle array for jetting black (Bk) ink, cyan (C) ink, magenta (M) ink, and yellow (Y) ink. The ink is supplied to the recording head 1024 from a sub-tank 1025 mounted to the carriage 1023. The ink of the sub-tank 1025 is supplied through a tube (not shown) connected to a main tank of an ink cartridge 1026 detachably attached to the main body 1001.

The sub-scan paper conveying part 1003 is for changing the orientation of the recording medium 1005 from the sheet feeding part to an angle of approximately 90 degrees and conveying the recording medium 1005 to the image forming part 1002. The sub-scan paper conveying part 1003 includes, for example, a conveyor belt (endless belt) 1031, a charging roller 1034, a guiding member 1035, a pressing roller 1036, and a conveying roller 1037. The conveyor belt 1031 is hung around a driving roller 1032 and a driven roller 1033. The charging roller 1034 is applied with AC bias for charging the surface of the conveyor belt 1031. The guiding member 1035 is for guiding the recording medium 1005 conveyed on the conveyor belt 1031 to an area of the image forming part 702 facing the conveyor belt 1031. The pressing roller 1036 is for pressing against the recording medium 1005 at the area of the image forming part 702 facing the conveyor belt 1031. The conveying roller 1037 is for conveying the recording medium 1005 from the image forming part 1002 to a sheet discharging part 1006.

The conveyor belt 1031 of the sub-scan paper conveying part 1003 is configured to rotate in the sub-scanning direction by having the conveying roller 1032 rotate via a sub-scan motor 1131, a timing belt 1132, and a timing roller 1133.

The sheet feeding part 1004 includes, for example, a sheet feed cassette 1041, a sheet feeding roller 1042, a friction pad 1043, and a sheet feed conveying roller (resist roller) 1044. The sheet feed cassette 1041, which is detachably attached to the main body 1001, has stacks of recording media provided therein. The sheet feeding roller 1042 and the friction pad 1043 enable the recording medium 1005 to be fed sheet by sheet from the sheet feed cassette 1041. The sheet feeding conveying roller 1044 conveys the paper from the sheet feed cassette 1041 to the sub-scan paper conveying part 1003. The sheet feed roller 1042 is rotated by a sheet feed motor (e.g. HB type stepping motor) 1141 via a sheet feed clutch (not shown). In addition, the sheet feed conveying roller 1044 is also rotated by the sheet feed motor 1141.

The sheet discharging part 1006 includes, for example, two pairs of sheet discharging rollers 1061, 1062 for conveying the recording medium 1005 on which an image is formed, and another two pairs of sheet discharging rollers 1063, 1064 for discharging the recording medium 1005 to the sheet discharge tray 1007.

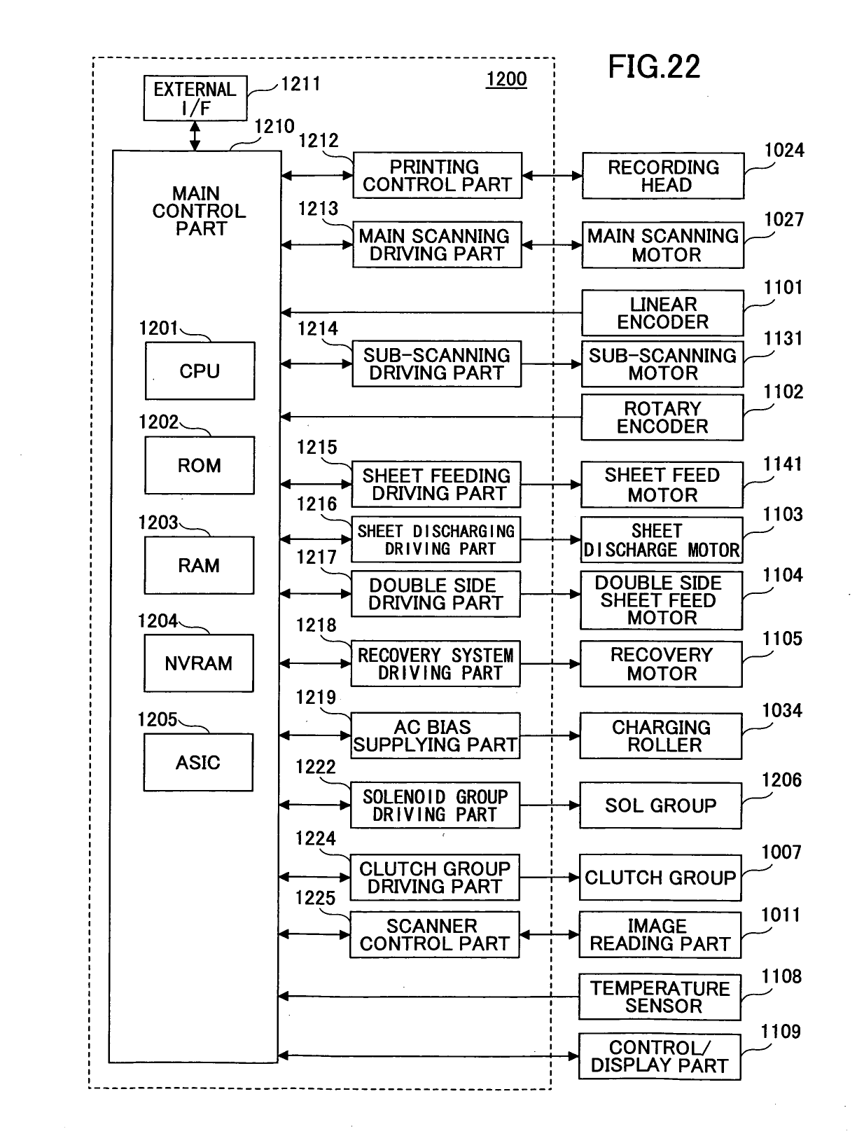

Next, a control part of the image forming apparatus 6000 according to another embodiment of the present invention is described with reference to FIG. 22.

The control part 1200 has a main control part 1210 for controlling various components provided therein. For example, the main control part 1210 controls a CPU 1201, a ROM 1202 for storing programs to be executed by the CPU 1201 and other fixed data, a RAM 1203 for temporarily storing image data and the like, a non-volatile memory (NVRAM) for maintaining data when the power of the image forming apparatus 6000 is turned off, and an ASIC 1205 for performing various image processes (e.g. halftone process) of the present invention with respect to input images.

The control part 1200 further includes, for example, an I/F 1211 for exchanging data and signals with the host (e.g. image processing apparatus), a printing control part 1212 including a head driver for controlling the drive of the recording head 1024, a main scanning driving part (motor driver) 1213 for driving a main scanning motor 1027 which moves the carriage 1023, a sub-scanning motor 1214 for driving the sub-scanning motor 1131, a sheet feeding driving part 1215 for driving the sheet feed motor 1141, a sheet discharging driving part 1216 for driving a sheet discharge motor 1103 that drives the rollers of the sheet feed part 1006, a double side driving part 1217 for driving a double side sheet feed motor 1217 that drives the rollers of a double side sheet feeding unit (not shown), a recovery system driving part 1218 for driving a recovery motor 1105 for driving a maintaining/recovering mechanism (not shown), and an AC bias supplying part 1219 for supplying AC bias to the charging roller 1034.

Moreover, the control part 1200 may also include, for example, a solenoid (SOL) group driving part (driver) 1222 for driving various solenoid groups 1206, a clutch driving part 1224 for driving electromagnetic clutch groups 1107 related to sheet feeding, and a scanner control part 1225 for controlling the image reading part 1011.

Furthermore, the main control part 1210 is input with detection signals from a temperature sensor for detecting the temperature of the conveyor belt 1031. It is to be noted that although detections signals of other sensor are also input to the main control part 1210, illustration of the sensors is omitted. Furthermore, the main control part 1210 outputs display information with respect to control/display part 1109 including various displays, keys, and buttons provided in the main body 1001 (e.g. numeric pad, start button).

Furthermore, the main control part 1210 is input with output signals (pulses) from a linear encoder 1101 for detecting the amount of movement and movement speed of the carriage 1023 and output signals (pulses) from a rotary encoder 1102 for detecting the movement speed and the movement speed of the conveyor belt 1031. Accordingly, the main control part 1210 moves the carriage 1023 and the conveyor belt 1031 by controlling the drive of the main scanning motor 1027 and the sub-scanning motor 1131 via the main scanning driving part 1213 and the sub-scanning driving part 1214 in correspondence with the detection signals (pulses) from the linear encoder 1101 and the rotary encoder 1102.

Next, an image forming operation of the image forming apparatus 6000 is described.

First, an alternate voltage (i.e. high voltage having rectangular waves of positive/negative electrodes) is applied to the charging roller 1034 from the AC bias supplying part 1219. Since the charging roller 1034 is in contact with the surface layer (insulating layer) of the conveyor belt 1031, positive and negative charges are alternately applied to the surface layer of the conveyor belt 1031 in the paper conveying direction of the conveyor belt 1031. Accordingly, a predetermined area of the conveyor belt 1031 is charged, to thereby create an unequal electric field in the conveyor belt 1031.

Then, a recording medium 1005 is fed from the sheet feeding part 1004 and conveyed onto the conveyor belt 1031 between the conveying roller 1032 and the pressing roller 1036. In accordance with the orientation of the electric field of the conveyor belt 1031, the recording medium 1005 is attracted to the surface of the conveyor belt 1031 by the electrostatic force of the conveyor belt 1031. Thereby, the recording medium 1005 is conveyed in correspondence with the movement of the conveyor belt 1031.

Thereby, an image (tone pattern) comprising an arrangement of dots is formed (printed) on the recording medium 1005 by jetting a recording liquid from the recording head 1024 while moving the recording head 1024 in the main scanning direction a plurality of times and intermittently conveying the recording medium 1005 in the sub-scanning direction in accordance with print data generated by the image processing apparatus. After the image (tone pattern) is formed, a front tip side of the recording medium 1005 is separated from the conveyor belt 1031 by a separating claw (not shown). Then, the recording medium 1005 is discharged to the sheet discharge tray 1007 by the sheet discharging part 1006.

Hence, in this embodiment of the present invention where the image forming apparatus 6000 reads an image from an original document with the scanner part 1011, uneven printing results and banding can be prevented by generating a mask pattern for moving the recording head in the main scanning direction and forming the arrangement of dots in an inconsecutive order on the recording medium.

Further, the present invention is not limited to these embodiments, but variations and modifications may be made without departing from the scope of the present invention.

The present application is based on Japanese Priority Application No. 2006-091604 filed on Mar. 29, 2006, with the Japanese Patent Office, the entire contents of which are hereby incorporated by reference.

What is claimed is:

1. An image processing method for processing image data to be output by an image forming apparatus, the image forming apparatus being configured to form a tone pattern on a recording medium by forming an arrangement of dots on the recording medium, the arrangement of dots being formed on the recording medium by jetting a recording liquid from a recording head while moving the recording head in a main scanning direction a plurality of times and intermittently conveying the recording medium in a sub-scanning direction that perpendicularly intersects the main scanning direction, the method comprising the step of:
generating a mask pattern for moving the recording head in the main scanning direction and forming the arrangement of dots in an inconsecutive order on the recording medium.

2. The image processing method as claimed in claim 1, wherein when the arrangement of dots is expressed by using the degree of scattering, the arrangement of dots is no greater than 5,
wherein the degree of scattering is expressed as Σ (interval of main scanning movement during dot forming operation−average of the intervals)²/number of scans for forming the tone pattern.

3. The image processing method as claimed in claim 1, wherein the mask pattern includes a pattern that defines the order of forming the dot arrangement in accordance with the results of a halftone process.

4. The image processing method as claimed in claim 1, wherein the mask pattern includes a halftone pattern used in a halftone process.

5. The image processing method as claimed in claim 1, wherein the mask pattern has a size that is different from the size of a halftone pattern used in a halftone process.

6. An image processing apparatus for processing image data to be output by an image forming apparatus, the image forming apparatus being configured to form a tone pattern on a recording medium by forming an arrangement of dots on the recording medium, the arrangement of dots being formed on the recording medium by jetting a recording liquid from a recording head while moving the recording head in a main scanning direction a plurality of times and intermittently conveying the recording medium in a sub-scanning direction that perpendicularly intersects the main scanning direction, the image processing apparatus comprising:
a mask pattern generating part for generating a mask pattern for moving the recording head in the main scanning direction and forming the arrangement of dots in an inconsecutive order on the recording medium.

7. The image processing apparatus as claimed in claim 6, wherein when the arrangement of dots is expressed by using the degree of scattering, the arrangement of dots is no greater than 5,
wherein the degree of scattering is expressed as Σ (interval of main scanning movement during dot forming operation−average of the intervals)²/number of scans for forming the tone pattern.

8. The image processing apparatus as claimed in claim 6, wherein the mask pattern includes a pattern that defines the order of forming the dot arrangement in accordance with the results of a halftone process.

9. The image processing apparatus as claimed in claim 6, wherein the mask pattern includes a halftone pattern used in a halftone process.

10. The image processing apparatus as claimed in claim 6, wherein the mask pattern has a size that is different from the size of a halftone pattern used in a halftone process.

11. A computer-readable recording medium on which a program is recorded for causing a computer to execute an image processing method for processing image data to be output by an image forming apparatus, the image forming apparatus being configured to form a tone pattern on a recording medium by forming an arrangement of dots on the recording medium, the arrangement of dots being formed on the recording medium by jetting a recording liquid from a recording head while moving the recording head in a main scanning direction a plurality of times and intermittently conveying the recording medium in a sub-scanning direction that perpendicularly intersects the main scanning direction, the method comprising the step of:
generating a mask pattern for moving the recording head in the main scanning direction and forming the arrangement of dots in an inconsecutive order on the recording medium.

12. The computer-readable recording medium as claimed in claim 11, wherein when the arrangement of dots is expressed by using the degree of scattering, the arrangement of dots is no greater than 5,
wherein the degree of scattering is expressed as Σ (interval of main scanning movement during dot forming operation−average of the intervals)²/number of scans for forming the tone pattern.

13. The computer-readable recording medium as claimed in claim 11, wherein the mask pattern includes a pattern that defines the order of forming the dot arrangement in accordance with the results of a halftone process.

14. The computer-readable recording medium as claimed in claim 11, wherein the mask pattern includes a halftone pattern used in a halftone process.

15. The computer-readable recording medium as claimed in claim 11, wherein the mask pattern has a size that is different from the size of a halftone pattern used in a halftone process.
